(19) United States
(12) Patent Application Publication
(10) Pub. No.: US 2025/0221429 A1
(43) Pub. Date: Jul. 10, 2025

(54) METHODS FOR PROCESSING ULTRA HIGH PROTEIN SOYBEANS, AND COMPOSITIONS RELATED THERETO

(71) Applicant: Benson Hill, Inc., St. Louis, MO (US)

(72) Inventors: Jason F. LOMBARDI, St. Charles, MO (US); Michael W. GIBSON, Decatur, IL (US); Savitha G. CHELLADURAI, Chicago, IL (US); Trent L. COLLINS, Lake Saint Louis, MO (US); Anthony J. KINGSLEY, Chicago, IL (US); Ali RASHID NIAGHI, Vadnais Heights, MN (US); Dustin A. BRUCKER, Ankeny, IA (US); Keith PETROFSKY, St. Louis, MO (US)

(73) Assignee: Benson Hill, Inc., St. Louis, MO (US)

(21) Appl. No.: 18/709,241

(22) PCT Filed: Nov. 11, 2022
(86) PCT No.: PCT/US2022/079738

§ 371 Date: May 10, 2024

Related U.S. Application Data
(60) Provisional application No. 63/278,995, filed on Nov. 12, 2021.

(51) Int. Cl. A23J 3/16; A23J 1/14; A23J 3/22; A23J 3/26; A23L 11/00

(52) U.S. Cl. CPC A23J 3/16; A23J 1/144; A23J 3/225; A23J 3/26; A23L 11/03

(57) ABSTRACT

The present disclosure relates generally to soybean products derived from high protein soybeans, and more specifically to soybean compositions having high protein content and methods of preparing and using such soybean compositions. The present disclosure also relates to uses of the soybean compositions in food products.

### CROSS-REFERENCE TO RELATED APPLICATIONS

This application claims priority to U.S. Provisional Patent Application No. 63/278,995, filed Nov. 12, 2021, which is incorporated herein by reference in its entirety.

### FIELD

The present disclosure relates generally to soybean products derived from high protein soybeans, and more specifically to soybean compositions having high protein content and methods of preparing and using such soybean compositions. The present disclosure also relates to uses of the soybean compositions in food products.

### BACKGROUND

Soybeans represent an attractive renewable source of protein for use in foodstuffs. However, the protein content of unprocessed soybeans is too low for many product applications. Further, unprocessed soybeans can contain unacceptably high concentrations of unwanted components, such as intrinsic oligosaccharides stachyose and raffinose, which are preferably removed through processing before the soy compositions can be used in certain products.

A major impediment to the production of high-protein soy compositions is the need for multiple expensive and time-consuming processing steps in order to remove unwanted components from the soybeans and increase the protein content of the resulting product. In some cases, these processing steps can have undesirable impacts on the functional properties of the resulting high-protein soy compositions.

Thus, there is a need not only for soy compositions having high protein content and desirable functional properties, but also for streamlined and inexpensive methods of producing these high-protein soy compositions.

### BRIEF SUMMARY

In one aspect, provided herein are methods of producing a protein-enriched soy composition, the method comprising providing soybeans, wherein the soybeans comprise at least about 48% soy protein on a dry weight basis, defatting the soybeans by solvent extraction to produce a defatted soybean composition, and desolventizing the defatted soybean composition to directly produce protein-enriched white flakes that comprise at least about 65% soy protein on a dry weight basis.

In another aspect, provided herein are protein-enriched white flakes obtainable by or produced according to the methods described herein. In another aspect, provided herein are protein-enriched white flakes, comprising at least about 65% soy protein and at least about 4% sugars on a dry weight basis, wherein the sugars are present in the soybeans from which the protein-enriched white flakes were obtained.

In one aspect, provided herein are methods of producing a protein-enriched soy compositions, the method comprising: a) providing soybeans, wherein the soybeans comprise at least about 48% soy protein on a dry weight basis; b) defatting the soybeans by solvent extraction to produce a defatted soybean composition; c) desolventizing the defatted soybean composition to directly produce protein-enriched white flakes; and d) grinding the protein-enriched white flakes to provide a protein-enriched soy flour, wherein the protein-enriched soy flour comprises at least about 60% soy protein on a dry weight basis.

In another aspect, provided herein is a protein-enriched soy flour obtainable by or produced according to the methods described herein. In still another aspect, provided herein is a protein-enriched soy flour, comprising at least about 60% soy protein on a dry weight basis and 4% sugars on a dry weight basis, wherein the sugars are present in the soybeans from which the protein-enriched soy flour was obtained.

In another aspect, provided herein is a protein-enriched texturized soy flour obtainable by or produced according to the methods described herein. In still another aspect, provided herein is a protein-enriched texturized soy flour, comprising at least about 60% soy protein on a dry weight basis and at least about 4% sugars on a dry weight basis, wherein the sugars are present in the soybeans from which the protein-enriched texturized soy flour was obtained.

In yet another aspect, provided herein is a food product, a beverage product, a dietary supplement product or other product, comprising protein-enriched white flakes as described herein, a protein-enriched soy flour as described herein or a protein-enriched texturized soy flour as described herein.

### DESCRIPTION OF THE FIGURES

The present application can be understood by reference to the following description taken in conjunction with the accompanying figures.

FIG. 1 shows a plot of protein content (percentage on dry weight basis) in protein-enriched white flakes, as compared to the protein content (percentage on dry weight basis) of the soybeans from which the protein-enriched white flakes are obtained.

FIG. 2 depicts a flowchart for an exemplary method of processing high protein soybeans to produce protein-enriched white flakes.

FIG. 3 depicts a flowchart for an exemplary method of processing high protein soybeans to produce protein-enriched soy flour.

FIGS. 4A and 4B compare the water holding capacity of a protein-enriched soy flour with that of two commercially available soy flours produced from commodity soybeans.

FIGS. 5A and 5B compare the oil holding capacity of a protein-enriched soy flour with that of two commercially available soy flours produced from commodity soybeans.

FIGS. 6A and 6B compare the foaming capacity of a protein-enriched soy flour with that of two commercially available soy flours produced from commodity soybeans.

FIGS. 7A and 7B compare the foaming stability of a protein-enriched soy flour with that of two commercially available soy flours produced from commodity soybeans.

FIGS. 8A and 8B compare the emulsification activity of a protein-enriched soy flour with that of two commercially available soy flours produced from commodity soybeans.

FIGS. 9A and 9B compare the emulsification stability of a protein-enriched soy flour with that of two commercially available soy flours produced from commodity soybeans.

FIGS. 10A and 10B compare the gelling strength of a protein-enriched soy flour with that of two commercially available soy flours produced from commodity soybeans.

FIG. 11 compares the least gelling concentration of a protein-enriched soy flour with that of two commercially available soy flours produced from commodity soybeans.

FIG. 12 compares two measurements of protein solubility (PDI and NSI) of a protein-enriched soy flour with those of two commercially available soy flours produced from commodity soybeans.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

High protein content soy ingredients are desirable for a variety of food products and applications. High protein soy ingredients are desirable for their nutritional properties, as well as the functional properties derived from their protein content. These functional properties are the intrinsic physicochemical characteristics which affect the behavior of a food ingredient in food systems during processing, manufacturing, storage and preparation. Such functional properties include water holding, oil binding, emulsification, foam capacity, gelation, whipping capacity, viscosity and others. Functional properties are important in determining the quality (nutritional, sensory, physicochemical and organoleptic properties) of the final product as well as facilitating processing such as improved machinability of cookie dough or slicing of processed meats. Therefore functional properties of food proteins are important in food processing and food product formulation. The functional behavior of proteins in food is influenced by some physicochemical properties of the proteins such as their size, shape, amino acid composition and sequence, net charge, charge distribution, hydrophobicity, hydrophilicity, type of structures, molecular flexibility/rigidity in response to external environment such as pH, temperature, salt concentration or interaction with other food constituents.

Seeds of soybean cultivars in the United States have an average composition of 20% oil, 40% protein, and 15% soluble carbohydrates in dry weights of cotyledons of ungerminated seeds. Hsu, et al. (1973). Traditional varieties of soybeans do not have a high enough protein content to achieve the functional properties required for certain products and applications. Traditionally, this has necessitated the processing of soybeans in order to produce soy products with an increased protein content. Typically, such processing involves at least a defatting step, to remove oils from the soybeans, and often a carbohydrate extraction step, to remove carbohydrates from the soybeans.

The two most commonly used processes for extracting carbohydrates from soy compositions are alcohol extraction and aqueous extraction at isoelectric pH. Both of these processes are expensive and time-consuming to implement on an industrial scale, and both processes have undesirable effects on the properties of the compositions they produce. Using an alcohol extraction process leads to irreversible denaturation of soy protein in the composition and loss of functionality. Using an aqueous carbohydrate extraction process results in lower salt tolerance, yellowish color, and lower emulsion and gel strengths in the resulting soy composition.

Disclosed herein is a process wherein an entirely different solution to the problem of achieving protein-enriched soy compositions is employed. Instead of processing traditional soybeans to increase their protein concentration, one can start with a soybean that has a high enough protein content that the carbohydrate extraction can be eschewed, and a soy composition with both a high protein content and desirable protein functionality can be obtained.

### A. High Protein Soybeans

As described above, provided herein are protein-enriched soy compositions having high protein content, which are derived from soybeans having high initial protein contents and methods of processing the same.

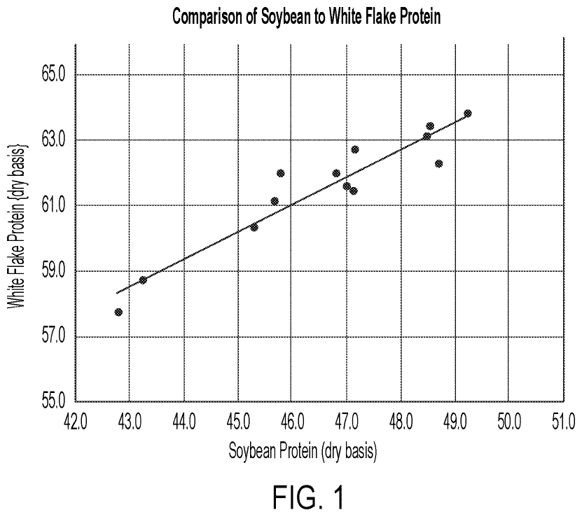

FIG. 1 illustrates an exemplary plot of protein contents of soy white flakes, which are a product of defatting soybeans, relative to the protein contents of soybeans from which the white flakes were produced. As shown in FIG. 1, the protein content in soy white flakes is directly proportional to the protein content initially present in the soybeans, and, thus, the protein content of any single origin soy product is limited to the initial protein content of the source soybeans.

In some embodiments, the soybeans of the present disclosure comprise high protein contents, which enables the production of protein-enriched white flakes and protein-enriched soy flours with fewer processing steps, as described for the methods of the present disclosure. In some embodiments, the soybeans comprise at least about 45%, at least about 46%, at least about 47%, at least about 48%, at least about 49%, at least about 50%, at least about 51%, or at least about 52% soy protein on a dry weight basis. In some embodiments, the soybeans comprise at least about 48% soy protein on a dry weight basis.

The soybeans comprising high protein content as employed by the methods of the present disclosure may be further characterized by one or more additional components present in the soybeans, such as oligosaccharide contents. The carbohydrate component of soybeans is comprised of three major oligosaccharides: sucrose, raffinose, and stachyose. Of the three, only sucrose is nutritionally useful and can be fully digested by monogastric animals. Raffinose and stachyose are considered anti-nutritional units because they cannot be digested due to the lack of a-galactosidase activity in the gut of monogastric animals.

In some embodiments of the present disclosure, the soybeans having high protein contents may also comprise low raffinose and/or stachyose content. In some embodiments, the soybeans of the present disclosure comprise less than or equal to about 0.13%, less than or equal to about 0.11%, less than or equal to about 0.1%, less than or equal to about 0.07%, less than or equal to about 0.06%, less than or equal to about 0.03%, or less than or equal to about 0.01% raffinose on a dry weight basis. In other embodiments, the soybeans of the present disclosure comprise between about 0% to about 0.13% raffinose on a dry weight basis. In some embodiments, the soybeans of the present disclosure comprise about 0.01%, 0.03%, 1.06%, 0.07%, 0.10%, 0.11% and 0.13% raffinose on a dry weight basis, including all integers and fractions thereof. In some embodiments, the soybeans of the present disclosure comprise less than or equal to about 0.13%, less than or equal to about 0.11%, less than or equal to about 0.1%, less than or equal to about 0.07%, less than or equal to about 0.06%, less than or equal to about 0.03%, or less than or equal to about 0.01% stachyose on a dry weight basis. In other embodiments, the soybeans of the present disclosure comprise about 0.02%, 0.05%, 0.07%, 0.12%, 0.16%, 0.21%, 0.26%, 0.34%, 0.38%, 0.48%, 0.49%, 0.51%, 0.55%, 0.59%, 0.63%, 0.67%, 0.78%, 0.80%, 0.85%, 0.91%, 0.96%, 1.12%, 1.19%, 1.23%, 1.28%, 1.33%, 1.38%, 1.45%, 1.49%, 1.56%, 1.57%, 1.63%, 1.68%, 1.71%, 1.73%, 1.75% stachyose on a dry weight basis, including all integers and fractions thereof.

In some embodiments, the soybeans comprise a combined raffinose and stachyose content of between about 0.02% and 1.75%.

The present invention is not limited to whether the soybeans comprise transgenic polynucleotides or proteins. The soybeans used in the Examples herein are non-transgenic and there are circumstances when using soybeans lacking transgenic traits, genome edits, or any other form of mutation (i.e. a change in a polynucleotide sequence) is necessary and/or beneficial. However, combining the teachings herein with a wide range of transgenic plants, or plants containing genome edits or any other form of mutation to confer new traits or combinations thereof is also envisioned.

### B. Methods of Processing

The present disclosure provides methods of processing soybeans having high protein content (e.g., at least about 48% soy protein on a dry weight basis) with reduced processing steps to obtain protein-enriched soy compositions, such as protein-enriched white flakes, protein-enriched soy flours, and protein-enriched texturized soy flours.

### I. Methods for Preparing Protein-Enriched White Flakes

In one aspect, provided herein is a method of producing a protein-enriched soy composition, the method comprising providing soybeans, wherein the soybeans comprise at least about 48% soy protein on a dry weight basis, defatting the soybeans by solvent extraction to produce a defatted soybean composition, and desolventizing the defatted soybean composition to directly produce protein-enriched white flakes that comprise at least about 60%, and in certain embodiments, at least about 65%, soy protein on a dry weight basis.

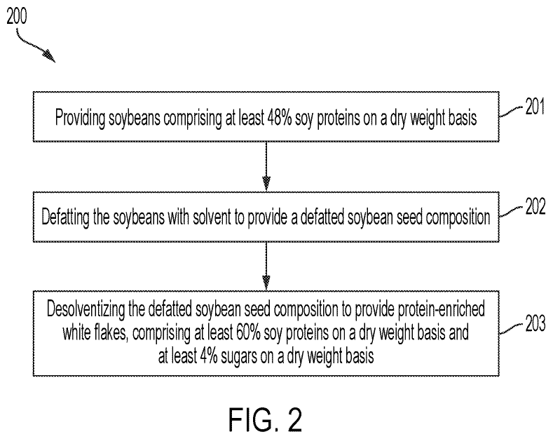

With reference to FIG. 2, process 200 is an exemplary process to prepare a protein-enriched soy composition. In step 201, soybeans comprising at least about 48% soy protein on a dry weight basis are provided. In step 202, the soybeans are defatted to provide a soybean seed composition. In step 203, the soybean seed composition is desolventized to provide protein-enriched white flakes, which comprise at least about 60% soy protein on a dry weight basis.

It should be understood that, in other variations, process 200 may include additional processing steps. In yet other variations, certain steps in process 200 may be omitted.

In some embodiments, step 201 further comprises cleaning the soybeans.

In some embodiments, step 201 further comprises tempering the soybeans. Methods of tempering soybeans are known in the art.

In some embodiments, step 201 further comprises cracking the soybeans.

In some embodiments, step 201 further comprises dehulling the soybeans. Any suitable techniques known in the art to remove the hulls from the soybeans may be employed. For example, in some variations, the soybeans are subjected to abrasive force in order to remove the hulls. In certain variations, dehulling may be carried out with an attrition mill or an impeller, or mechanical equivalent. In one variation, the dehulling step does not utilize wet removal methods, such as blanching, alkaline and/or aqueous dissolution. In certain embodiments, the soybeans undergo thermal treatment prior to hull removal. In some variations, such thermal treatment is a dry dehulling process, which is distinguished from a wet dehulling process that may involve, for example, blanching. In certain embodiments, the soybeans subjected to the thermal treatment may be characterized by their moisture content. In some variations, the treated soybeans obtained from the thermal treatment have a moisture content of less than or equal to about 20% w/w, less than or equal to about 17% w/w, less than or equal to about 15% w/w, less than or equal to about 12% w/w, less than or equal to about 10% w/w, or less than or equal to about 8% w/w, without further drying. In other variations, the treated soybeans obtained from the thermal treatment have a moisture content of between about 5% w/w and about 20% w/w, between about 5% w/w and about 17% w/w, between about 5% w/w and about 15% w/w, between about 5% w/w and about 12% w/w, between about 5% w/w and about 10% w/w, between about 5% w/w and about 8% w/w, between about 8% w/w and about 20% w/w, between about 8% w/w and about 17% w/w, between about 8% w/w and about 15% w/w, between about 8% w/w and about 12% w/w, between about 8% w/w and about 10% w/w, between about 10% w/w and about 20% w/w, between 10% w/w and about 17% w/w, between about 10% w/w and about 15% w/w, between about 10% w/w and about 12% w/w, between about 12% w/w and about 20% w/w, between about 12% w/w and about 17% w/w, between about 12% w/w and about 15% w/w, between about 15% w/w and about 20% w/w, between about 15% w/w and about 17% w/w, or between about 17% w/w and about 20% w/w, without further drying. In yet other variations, the treated soybeans obtained from the thermal treatment may be dried in order to control the moisture content prior to further processing to remove oil and obtain a defatted soybean.

In some variations, removing the hulls from the soybeans results in a mixture comprising dehulled soybeans and detached hulls. As such, the method may further comprise separating the detached hulls from the dehulled soybeans. In some embodiments, the method further comprises separating the dehulled soybeans from the detached hulls by hand separation, by sieving or screening, or aerodynamic separation (i.e., weight classification by aspiration).

In some embodiments, step 201 further comprises flaking the soybeans. In some such embodiments, flaking may be achieved by rolling the beans between two smooth cylindrical rollers. In some such embodiments, the soybeans may be pre-treated with heat and steam to facilitate flaking. In other embodiments, step 201 further comprises grinding the soybeans.

In some embodiments, the defatting process of step 202 involves combining the soybeans with a solvent to provide an extraction mixture. In some embodiments, the solvent used to defat the beans in step 202 may be a nonpolar solvent. In some embodiments, the solvent is an alkane solvent. In some such embodiments, the solvent may be hexane. In some embodiments, the solvent is water. In some embodiments, the solvent is not an alcohol. In some embodiments, the solvent may contain one or more co-solvents.

In some such embodiments, combining the soybeans and the solvent comprises combining the soybeans and the solvent in an extractor to provide an extraction mixture. In certain embodiments, the step of combining comprises mixing, agitating, or stirring the extraction mixture in an extractor. In some embodiments, combining the soybeans and the solvent to provide an extraction mixture comprises heating the soybeans and the solvent to provide an extraction mixture. In still other embodiments, the method further comprises heating the extraction mixture. It should be noted that the foregoing methods may include variations of other parameters that may be part of the combining step including, for example, the residence time of the extraction mixture in the extractor, extractor temperature and pressure, extractor chain speed, particle size distribution of the soybeans, the ratio of soybeans to the solvent, and feed rates of the soybeans and solvent into the extractor.

In some embodiments, the extraction mixture is separated into a miscella and a defatted soybean composition. The miscella primarily contains the liquid fraction of the extraction mixture (oil, solvent, and any soluble compounds), whereas the defatted soybean composition largely is composed of the residual insoluble solid material, or meal, that remains from the soybeans. The step of separating the extraction mixture into a miscella and a defatted soybean composition may include any suitable methods known in the art for the solid-liquid separations. In certain embodiments, the extraction mixture is separated by filtration. In other embodiments, the extraction mixture is separated by decanting.

As described above, the defatted soybean composition largely is composed of the residual insoluble solid material, that remains from the soybeans following extraction with the solvent of step 202 and solid-liquid separation to remove the miscella. The resulting defatted soybean composition comprising less than about 3% fat as described herein may further comprise any of number of components, such as carbohydrates, sugars, proteins, fiber, ash, or other components, that are originally present in the soybeans. For example, in some embodiments the defatted soybean composition comprises at least about 60% protein by dry weight. In certain embodiments, the defatted soybean composition comprises about 60-65% protein by dry weight. In other embodiments wherein the defatted soybean composition comprises total dietary fiber, the soybean composition comprises at most about 20% total dietary fiber by dry weight.

It should be recognized that, due to the nature of the extraction method described herein comprising combining soybeans with a solvent, the defatted soybean composition may contain residual levels of the solvent. For example, the defatted soybean composition may contain residual levels of hexane and any co-solvents used, even after separation of the miscella from the defatted soybean composition. Thus, in some embodiments, the defatted soybean composition comprises solvent. In certain embodiments, the defatted soybean composition has a solvent concentration of less than about 100,000 ppm. In other embodiments wherein the solvent combined with the soybeans comprises hexane, the defatted composition comprises hexane. In certain embodiments wherein the defatted soybean composition comprises hexane, the defatted soybean composition has a hexane concentration of less than about 100,000 ppm.

Thus, the method of the present disclosure further includes the desolventization process of step 203. In some embodiments, the desolventization process of step 203 comprises a dry heating or toasting step to de-solventize, that is, to reduce the level of solvent in, the defatted soybean composition. Therefore, in some embodiments, the method further comprises toasting the defatted soybean composition to provide a toasted defatted soybean composition. In other embodiments, the desolventization process of step 203 comprises a flash desolventization step, wherein the defatted soybean composition is contacted with superheated solvent vapors in order to reduce the level of solvent in the defatted soybean composition. In some embodiments, wherein the solvent is hexane, the flash desolventization step comprises contacting the defatted soybean composition with hexane vapors. In some such embodiments, the hexane vapors are heated. In some wherein the desolventization process of step 203 comprises a flash desolventization step, the flash desolventization step further comprises contacting the defatted soybean composition with steam to further reduce the level of solvent in the defatted soybean composition. In some embodiments, the flash desolventization step is performed under vacuum.

In some embodiments, following desolventization of the defatted soybean composition, the defatted soybean composition comprises a solvent and has a solvent concentration of less than or equal to about 5,000 ppm. In certain embodiments, the desolventized defatted soybean composition has a solvent concentration between about 0 ppm and about 5,000 ppm, between about 0 ppm and about 1,000 ppm, between about 1,000 ppm and about 3,000 ppm, or between about 3,000 ppm and about 5,000 ppm. In still yet other embodiments wherein the solvent is hexane, the desolventized defatted soybean composition comprises hexane and has a hexane concentration of less than or equal to about 5,000 ppm. In certain embodiments wherein the solvent is hexane, the desolventized defatted soybean composition comprises hexane and has a hexane concentration between about 0 ppm and about 5,000 ppm, between about 0 ppm and about 1,000 ppm, between about 1,000 ppm and about 3,000 ppm, or between about 3,000 ppm and about 5,000 ppm.

In some embodiments, the defatted desolventized soybean composition described above is the protein-enriched white flake composition provided by step 203. In some embodiments, the protein-enriched white flakes provided by step 203 comprise at least about 55% protein on a dry weight basis. In some such embodiments, the protein-enriched white flakes comprise at least about 60% protein on a dry weight basis. In some such embodiments, the protein-enriched white flakes comprise at least about 65% protein on a dry weight basis.

It should be recognized that the methods of the present disclosure directly produce protein-enriched white flakes from the defatted soybean composition in the process of desolventization. As used herein, to “directly produce” protein-enriched white flakes means to do so without additional steps and/or without the addition/removal of material (such as soluble carbohydrates), and/or without changing the environment, in order to increase the protein content of the white flakes. An example of a production process that is not direct is one using an additional alcohol and/or water extraction step on the white flakes to arrive at a protein-enriched soy product, e.g. a soy protein concentrate. Another example of a production process that is not direct is one using ultrafiltration of slurried white flakes to arrive at a protein-enriched soy product, e.g. a soy protein concentrate.

In some embodiments, the protein-enriched white flakes provided by step 203 comprise at least about one of the following compositional features: (i) less than or equal to about 3% crude fat on a dry weight basis, (ii) less than or equal to about 5% fat on a dry weight basis (as determined by acid hydrolysis), (iii) less than or equal to about 20% total dietary fiber on a dry weight basis, (iv) less than or equal to about 7% ash on a dry weight basis, or (v) less than or equal to about 12% moisture on a dry weight basis. In some embodiments, the protein-enriched white flakes comprise any combination of (i)-(v). In some embodiment, the protein-enriched white flakes comprise all of (i)-(v).

In some embodiments, the protein-enriched white flakes provided by step 203 comprise at least about 4% sugars on a dry weight basis. In some such embodiments, the protein-enriched white flakes comprise at least about 4%, at least about 5%, at least about 6%, at least about 7%, at least about 8%, at least about 9%, or at least about 10% sugars on a dry weight basis. In some such embodiments, the protein-enriched white flakes comprise at least about 10% sugars on a dry weight basis. In some embodiments, the protein-enriched white flakes comprise at least about 4% sugars, and at least about 60% soy protein on a dry weight basis. In some embodiments, the protein-enriched white flakes comprise at least about 4% sugars, and at least about 65% soy protein on a dry weight basis. In some embodiments, the sugars are present in the soybeans from which the protein-enriched white flakes were obtained.

In some embodiments, the protein-enriched white flakes provided by step 203 have at least one of the following properties: improved characteristics selected from improved average ratio of 11S soy protein (glycinin) to 7S soy protein (β-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof. In some embodiments, the protein-enriched white flakes have any combinations of the above. In some embodiments, the protein-enriched white flakes have all of the above. In some embodiments, the improved characteristics as described above are improved as compared to the same properties of protein-enriched white flakes obtained by methods employing carbohydrate extraction methods after defatting and desolventization.

In some embodiments, the protein-enriched white flakes provided by step 203 comprise one or more of the following: (i) at least about 1% saponins on a dry weight basis, (ii) at least about 50 mg/g of β-conglycinin (7S soy protein) on a dry weight basis, (iii) at least about 10 ppm glycinin (11S soy protein) antigen, (iv) at least about 10 ppm of lectins, or (v) less than or equal to 20 mg isoflavones per 100 gram protein-enriched soy ingredient. In some embodiments, the protein-enriched white flakes comprise any combination of (i)-(v). In some embodiments, the protein-enriched white flakes comprise at least about 65% protein on a dry weight basis and any combination of (i)-(v). In some embodiments, the protein-enriched white flakes comprise all of (i)-(v). In some embodiments, the protein-enriched white flakes comprise at least about 65% protein on a dry weight basis and all of (i)-(v).

In some embodiments, the protein-enriched white flakes are further processed to produce textured soy protein (“texturized”). In some embodiments, texturization is accomplished using an extrusion process, such as with a twin-screw extruder. Accordingly, in some embodiments, the methods of the present disclosure further comprise extruding the protein-enriched white flakes to provide a protein-enriched texturized white flakes.

In some embodiments, provided is a method of processing soybeans, the method comprising providing high protein soybeans, wherein the high protein soybeans comprise a greater proportion of soy protein than commodity soybeans, defatting the high protein soybeans by solvent extraction to produce a defatted soybean composition, and desolventizing the defatted soybean composition to directly produce protein-enriched soy white flakes that comprise at least about 55% soy protein on a dry weight basis. In some embodiments, the high protein soybeans have a protein content of at least about 48% on a dry weight basis. In some embodiments, the process uses less than 500 kg of water per ton of soy white flake composition produced. In some embodiments, the process uses less than 100 kWh of electricity per ton of soy white flake composition produced. In some embodiments, the process results in the release of less than 0.06 tons of CO₂ into the atmosphere per ton of soy white flake composition produced. In some embodiments, providing the high protein soybeans comprises cultivating soybeans, harvesting the soybeans, and transporting the soybeans from a harvesting location to a processing location, and the method results in the release of less than 0.2 tons of CO₂ into the atmosphere per ton of soy white flakes produced. In some embodiments, providing the high protein soybeans comprises cultivating soybeans, harvesting the soybeans, and transporting the soybeans from a harvesting location to a processing location, and the method results in the release of 60% less CO₂ into the atmosphere per ton of soy white flakes produced as compared to a soy flour produced from commodity soybeans.

### II. Methods for Preparing Protein-Enriched Soy Flour and Texturized Soy Flour

In another aspect, provided herein is a method for producing a protein-enriched soy flour, the method comprising providing soybeans, wherein the soybeans comprise at least about 48% soy protein on a dry weight basis, defatting the soybeans by solvent extraction to produce a defatted soybean composition, desolventizing the defatted soybean composition to directly produce protein-enriched white flakes that comprise at least about 60% soy protein on a dry weight basis, and grinding the protein-enriched white flakes to produce a protein-enriched soy flour that comprises at least about 60% soy protein on a dry weight basis. Grinding can be performed using any suitable techniques known in the art. For example, grinding can be performed using equipment such as hammer mill, FitzMill or Quadromill.

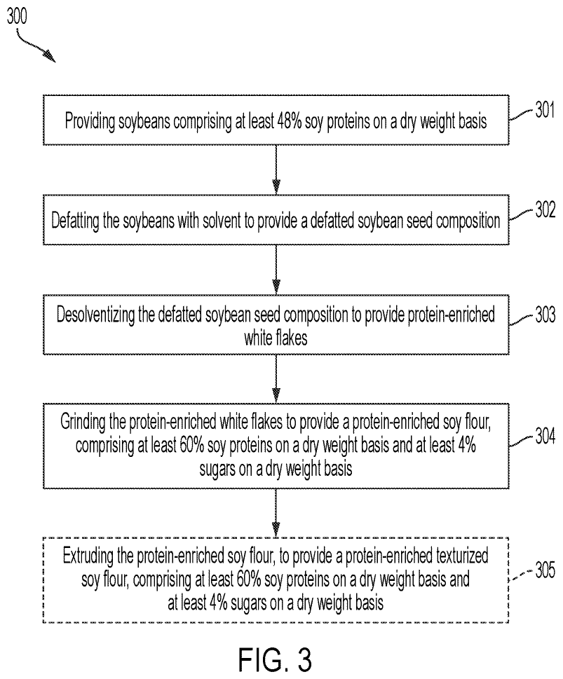

With reference to FIG. 3, process 300 is an exemplary process to prepare a protein-enriched soy flour. In step 301, soybeans comprising at least about 48% soy protein on a dry weight basis are provided. In step 302, the soybeans are defatted to provide a soybean seed composition. In step 303, the soybean seed composition is desolventized to provide protein-enriched white flakes, which comprise at least about 60% soy protein on a dry weight basis. In step 304, the protein-enriched white flakes are ground to provide a protein-enriched soy flour comprising at least about 60% soy protein on a dry weight basis.

It should be understood that, in other variations, process 300 may include additional processing steps. In yet other variations, certain steps in process 300 may be omitted.

It should be further understood that any single embodiment, or any combination of embodiments as described for any of the steps of process 100 may apply to process 300 for producing a protein-enriched soy flour.

In some embodiments, the grinding of step 304 comprises grinding the protein-enriched white flakes until at least about 97% of the product can pass through a 100-mesh standard screen.

In some embodiments, provided is a method of processing soybeans, the method comprising providing high protein soybeans, wherein the high protein soybeans comprise a greater proportion of soy protein than commodity soybeans, defatting the high protein soybeans by solvent extraction to produce a defatted soybean composition, desolventizing the defatted soybean composition to directly produce protein-enriched soy white flakes, and grinding the protein-enriched soy white flakes to provide a protein-enriched soy flour that comprises at least about 55% soy protein on a dry weight basis. In some embodiments, the high protein soybeans have a protein content of at least about 48% on a dry weight basis. In some embodiments, the process uses less than 500 kg of water per ton of soy flour produced. In some embodiments, the process uses less than 150 kWh of electricity per ton of soy flour produced. In some embodiments, the process results in the release of less than 0.07 tons of CO₂ into the atmosphere per ton of soy flour produced. In some embodiments, providing the high protein soybeans comprises cultivating soybeans, harvesting the soybeans, and transporting the soybeans from a harvesting location to a processing location, and the method results in the release of less than 0.25 tons of CO₂ into the atmosphere per ton of soy flour produced. In some embodiments, providing the high protein soybeans comprises cultivating soybeans, harvesting the soybeans, and transporting the soybeans from a harvesting location to a processing location, and the method results in the release of 60% less CO₂ into the atmosphere per ton of soy flour produced as compared to a soy flour produced from commodity soybeans.

With reference again to process, 300, in step 305, in some embodiments, the protein-enriched flour is further processed to produce textured soy protein (“texturized”). In some embodiments, texturization is accomplished using an extrusion process, such as with a twin-screw extruder. Accordingly, in some embodiments, the methods of the present disclosure further comprise extruding the protein-enriched soy flour to provide a protein-enriched texturized soy flour.

### III. Methods for Preparing Protein-Enriched Soybean Meal

In another aspect, provided herein is a method for processing soybeans, the method comprising providing high protein soybeans, wherein the high protein soybeans comprise a greater proportion of soy protein than commodity soybeans, defatting the high protein soybeans by solvent extraction to produce a defatted soybean composition, and desolventizing the defatted soybean composition to directly produce protein-enriched soybean meal that comprises at least about 50% soy protein on a dry weight basis. In some embodiments, the high protein soybeans have a protein content of at least about 48% on a dry weight basis. In some embodiments, the method uses less than 500 kg of water per ton of soybean meal produced. In some embodiments, the method uses less than 100 kWh of electricity per ton of soybean meal produced. In some embodiments, the method results in the release of less than 0.06 tons of CO₂ into the atmosphere per ton of soybean meal produced. In some embodiments, providing the high protein soybeans comprises cultivating soybeans, harvesting the soybeans, and transporting the soybeans from a harvesting location to a processing location, and the method results in the release of less than 0.2 tons of CO₂ into the atmosphere per ton of soybean meal produced.

### C. Compositions

In addition to the methods of processing soybeans having high protein content (e.g., at least about 48% soy protein on a dry weight basis) with reduced processing steps provided herein, the present disclosure also provides protein-enriched soy compositions, such as protein-enriched white flakes, protein-enriched soy flours, and protein-enriched texturized soy flours.

### I. Protein-Enriched White Flakes

In one aspect, provided herein are protein-enriched white flakes. In one aspect, provided herein are protein-enriched white flakes comprising at least about 60% soy protein on a dry weight basis. In one aspect provided herein are protein-enriched white flakes obtainable or produced by the methods according to the present disclosure.

In another aspect, provided are protein-enriched white flakes comprising at least about 65% soy protein on a dry weight basis and at least about 4% sugars on a dry weight basis, wherein the sugars are present in the soybeans from which the protein enriched white flakes were obtained. The compositions and properties of the protein-enriched white flakes are described in further detail below.

### Soy Protein Content

The protein-enriched white flakes provided herein have a high soy protein content, including relative to the soy protein content of the soybeans from which the enriched flakes were obtained.

In some embodiments, the protein-enriched white flakes comprise at least about 60%, at least about 65%, at least about 70%, at least about 75%, at least about 80%, at least about 85%, or at least about 90% soy protein on a dry weight basis. In some embodiments, the protein-enriched white flakes comprise between about 60% and about 80%, between about 60% and about 75%, between about 60% and about 70%, between about 60% and about 65%, between about 65% and about 80%, between about 65% and about 75%, or between about 65% and about 70% soy protein on a dry weight basis.

In certain embodiments, the protein-enriched white flakes have at least about 1.1 times, at least about 1.2 times, at least about 1.25 times, at least about 1.3 times, at least about 1.35 times, at least about 1.4 times, at least about 1.5 times, at least about 1.7 times, or at least about 2 times more soy protein per unit weight than the soybeans from which the white flakes were obtained. In some embodiments, the protein-enriched white flakes comprise between about 1.2 and about 1.4 times more soy protein than the soybeans from which the enriched compositions were obtained.

### Carbohydrate Content

In some embodiments, the protein-enriched white flakes provided herein have a higher carbohydrate content relative to soy protein concentrate (SPC) compositions with comparable protein compositions, obtained using a process comprising a carbohydrate extraction step.

It should also be recognized that the protein-enriched soy compositions of the present disclosure may comprise a particular profile of carbohydrates, including oligosaccharide content and soluble or insoluble fiber ratios, reflective of the methods of the present disclosure, which eschew any processing steps of removing carbohydrates in order to increase protein content. The carbohydrate and/or fiber composition of the protein-enriched soy compositions may distinguish the compositions from other commercially available soy products produced by methods involving removal of carbohydrates or from soy products prepared from blends of soy flours, soy protein concentrates, and/or soy protein isolates. It should be further recognized that the carbohydrate and/or fiber profiles of the protein-enriched soy compositions provided herein may contribute to their functional properties. In some embodiments, the protein-enriched white flakes are unblended, and are substantially free of soy protein concentrate or soy protein isolate.

In some embodiments, the protein-enriched white flakes provided herein have a protein content of at least about 60% or at least about 65% soy protein on a dry weight basis and at least about 3%, at least about 4%, at least about 5%, at least about 6%, at least about 7%, at least about 8%, at least about 9%, at least about 10%, at least about 12%, at least about 14%, or at least about 16% sugar content on a dry weight basis.

In some such embodiments, the protein-enriched white flakes comprise at least about 4%, at least about 5%, at least about 6%, at least about 7%, at least about 8%, at least about 9%, or at least about 10% sugars on a dry weight basis. In some such embodiments, the protein-enriched white flakes comprise at least about 10% sugars on a dry weight basis. In some embodiments, the protein-enriched white flakes comprise at least about 4% sugars on a dry weight basis. In some embodiments, the protein-enriched white flakes comprise at least about 4% sugars, and at least about 60% soy protein on a dry weight basis. In some embodiments, the protein-enriched white flakes comprise at least about 4% sugars, and at least about 65% soy protein on a dry weight basis. In some embodiments, the sugars are present in the soybeans from which the protein-enriched white flakes were obtained.

In some embodiments, the protein-enriched white flakes may be characterized by the content of certain oligosaccharides, including but not limited to sucrose, stachyose, and raffinose, which contribute to the total sugar content.

In some embodiments, the protein-enriched white flakes provided herein have a stachyose content of less than or equal to about 10%, less than or equal to about 9%, less than or equal to about 8%, less than or equal to about 7.5%, less than or equal to about 7%, less than or equal to about 6%, less than or equal to about 5%, less than or equal to about 4%, or less than or equal to about 2% on a dry weight basis. In some embodiments, the protein-enriched white flakes provided herein have a raffinose content of less than or equal to about 5%, less than or equal to about 4.5%, less than or equal to about 4%, less than or equal to about 3.5%, less than or equal to about 3%, less than or equal to about 2.5%, less than or equal to about 2%, less than or equal to about 1.5%, or less than or equal to about 1% on a dry weight basis.

In some embodiments, the protein-enriched white flakes have at least about 0.1%, at least about 0.2%, at least about 0.3%, at least about 0.4%, at least about 0.5%, at least about 0.7%, at least about 1%, at least about 1.5%, at least about 2%, at least about 2.5%, at least about 3%, at least about 4%, at least about 5%, at least about 6%, at least about 8%, or at least about 10% raffinose on a dry weight basis. In some embodiments, the protein-enriched white flakes have at least about 0.5%, at least about 0.6% at least about 0.7%, at least about 0.8%, at least about 0.9%, at least about 1%, at least about 1.5%, at least about 2%, at least about 3%, at least about 4%, at least about 5%, at least about 6%, at least about 7%, at least about 8%, at least about 9%, at least about 10%, at least about 12%, or at least about 14% stachyose on a dry weight basis. In some embodiments, the protein-enriched white flakes have at least about 2%, at least about 3%, at least about 4%, at least about 5%, at least about 6%, at least about 7%, at least about 8%, at least about 9%, at least about 10%, at least about 12%, or at least about 14% sucrose on a dry weight basis.

In some embodiments, the protein-enriched white flakes provided herein have a lower concentration of undesirable oligosaccharides relative to white flakes produced by defatting and desolventizing soybeans that have a protein content of less than or equal to about 45% on a dry weight basis. For example, high protein soybeans having low concentrations of raffinose and stachyose may be employed by the methods as described herein to provide soy protein compositions having high protein as well as low concentrations of raffinose and stachyose, despite the omission of a carbohydrate extraction step after defatting and desolventization. In some embodiments wherein the protein-enriched white flakes provided herein are obtained from soybeans having low raffinose and/or stachyose content, the raffinose and/or stachyose content of the resulting white flakes may also be similarly low. In some embodiments, wherein the protein-enriched white flakes provided herein are obtained from soybeans having low raffinose and/or stachyose content as described herein, the protein-enriched white flakes have a stachyose content of at least about 0.5%, at least about 0.6% at least about 0.7%, at least about 0.8%, at least about 0.9%, at least about 1% on a dry weight basis. In some embodiments, wherein the protein-enriched white flakes provided herein are obtained from soybeans having low raffinose and/or raffinose content as described herein, the protein-enriched white flakes have a raffinose content of at least about 0.1%, at least about 0.2%, at least about 0.3%, at least about 0.4%, at least about 0.5%.

In some embodiments, the protein-enriched white flakes have at least about 0.1% or at least about 0.2% raffinose on a dry weight basis. In some embodiments, the protein-enriched white flakes have at least about 0.5% or at least about 1% stachyose on a dry weight basis. In other embodiments, the protein-enriched white flakes have (i) at least about 0.1% raffinose on a dry weight basis; (ii) at least about 0.5% stachyose on a dry weight basis, or (iii) a combination of at least about 0.1% raffinose and at least about 0.5% stachyose on a dry weight basis. In other embodiments, the protein-enriched white flakes have (i) at least about 0.2% raffinose on a dry weight basis; (ii) at least about 1% stachyose on a dry weight basis, or (iii) a combination of at least about 0.2% raffinose and at least about 1% stachyose on a dry weight basis.

In some embodiments, the protein-enriched white flakes provided herein have a lower total dietary fiber content relative to white flakes produced by defatting and desolventizing soybeans that have a protein content of less than 45% on a dry weight basis.

In some embodiments, the protein-enriched white flakes provided herein have a total dietary fiber of less than or equal to about 30%, less than or equal to about 25%, less than or equal to about 22%, less than or equal to about 20%, less than or equal to about 18%, less than or equal to about 16%, less than or equal to about 14%, less than or equal to about 12%, or less than or equal to about 10% total dietary fiber on a dry weight basis. In some embodiments, the protein-enriched white flakes provided herein have a total dietary fiber of less than or equal to about 20%.

In some embodiments, the protein-enriched white flakes of the present disclosure have at least about 2%, at least about 5%, at least about 10%, at least about 15%, or at least about 20% soluble fiber on a dry weight basis. In other embodiments, protein-enriched white flakes of the present disclosure have at least about 2%, at least about 5%, at least about 10%, at least about 15%, or at least about 20% insoluble fiber on a dry weight basis.

### Fat Content

In some embodiments, the protein-enriched white flakes provided herein have a crude fat composition of less than or equal to about 3%, less than or equal to about 2%, or less than or equal to about 1% on a dry weight basis. In some embodiments, the protein-enriched white flakes provided herein have less than or equal to about 3% on a dry weight basis

In some embodiments, the protein-enriched white flakes provided herein have a fat composition of less than or equal to about 5%, less than or equal to about 4%, less than or equal to about 3%, less than or equal to about 2%, or less than or equal to about 1% on a dry weight basis (as determined by acid hydrolysis). In some embodiments, the protein-enriched white flakes provided herein have less than or equal to about 5% on a dry weight basis (as determined by acid hydrolysis).

### Ash and Moisture Content

In some embodiments, the protein-enriched white flakes have less than or equal to about 7%, less than or equal to about 6%, less than or equal to about 5%, or less than or equal to about 4% ash on a dry weight basis. In some embodiments, the protein-enriched white flakes have less than or equal to about 7% ash on a dry weight basis.

In some embodiments, the protein-enriched white flakes have less than or equal to about 12%, less than or equal to about 11%, less than or equal to about 10%, less than or equal to about 9%, less than or equal to about 8%, or less than or equal to about 7% moisture on a dry weight basis. In some embodiments, the protein-enriched white flakes have less than or equal to about 12% moisture on a dry weight basis.

### Other Components

In some embodiments, the protein-enriched white flakes have at least one of the following properties: improved characteristics selected from improved average ratio of 11S soy protein (glycinin) to 7S soy protein (B-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof. In some embodiments, the protein-enriched white flakes have any combinations of the above. In some embodiments, the protein-enriched white flakes have all of the above. In some embodiments, the improved characteristics as described above are improved as compared to the same properties of white flakes obtained by methods employing carbohydrate extraction methods after defatting and desolventization.

In some embodiments, the protein-enriched white flakes provided herein have a higher concentration of certain compounds and relative to soy protein concentrate (SPC) compositions with comparable protein compositions, obtained using an alcohol extraction step.

In some embodiments, the protein-enriched white flakes have at least about 1%, at least about 2%, at least about 3%, at least about 4%, at least about 5%, at least about 6%, at least about 7%, at least about 8%, at least about 9%, at least about 10%, at least about 12%, or at least about 14% saponins on a dry weight basis.

In some embodiments, the protein-enriched white flakes provided herein have a concentration of B-conglycinin (7S soy protein) of at least about 50 mg/g. In some embodiments, the protein-enriched white flakes provided herein have at least about 10 ppm glycinin (11S soy protein). In some embodiments, the protein-enriched white flakes provided herein have at least about 10 ppm of lectins. In some embodiments, the protein-enriched white flakes provided herein have less than or equal to 20 mg isoflavones per 100 g protein-enriched white flake.

In some embodiments, the protein-enriched white flakes comprise one or more of the following: (i) at least about 1% saponins on a dry weight basis, (ii) at least about 50 mg/g of β-conglycinin (7S soy protein) on a dry weight basis, (iii) at least about 10 ppm glycinin (11S soy protein) antigen, (iv) at least about 10 ppm of lectins, or (v) less than or equal to 20 mg isoflavones per 100 gram protein-enriched soy ingredient. In some embodiments, the protein-enriched white flakes comprise any combination of (i)-(v). In some embodiments, the protein-enriched white flakes comprise any combination of (i)-(v). In some embodiments, the protein-enriched white flakes comprise all of (i)-(v). In some embodiments, the protein-enriched white flakes comprise all of (i)-(v).

### Functional Properties

As provided herein, the protein-enriched white flakes obtained according to the methods of the present disclosure comprise high protein content as well as high carbohydrate content, among other composition attributes described above. The compositional profiles of the protein-enriched white flakes as well as the minimal processing steps used to obtain the protein-enriched white flakes contribute to the functional properties of the resulting white flakes. The protein-enriched white flakes may be characterized by any number of functional properties, including but not limited to protein dispersibility, nitrogen/protein solubility, foaming properties, viscosity, water and oil holding capacities, emulsification properties, and/or gelling properties.

In some embodiments, the protein-enriched soy flour of the present disclosure may be characterized by various functional properties according to methods known in the art or according to any of the protocols as described herein. In some embodiments, the protein-enriched soy flour of the present disclosure may be characterized by any one of the following functional properties: protein dispersibility index (PDI), protein solubility, foaming capacity, foaming stability, viscosity, water holding capacity, oil holding capacity, emulsification activity, emulsification stability, median emulsion droplet size, minimum gelling concentration, gelling strength, bulk density, and/or texture properties. In some embodiments, the functional properties of the protein-enriched soy compositions, including the protein-enriched white flakes, protein-enriched soy flours, and protein-enriched texturized soy flours described herein may be evaluated by methods known in the art and/or methods as described herein, such as in Example 2.

In some embodiments, the protein-enriched white flakes provided herein have a higher protein dispersibility index (PDI), relative to soy protein concentrate (SPC) compositions with comparable protein compositions, obtained using a process comprising an alcohol extraction step. The compositions and methods of the present disclosure achieve higher protein dispersibility index values by virtue of the higher initial protein content of the originating soybeans from which the compositions are obtained in combination with processing methods that exclude a step to remove soluble matter (such as sugars) from the compositions, to achieve higher protein content.

PDI may be measured using any suitable techniques known in the art. For example, in one variation, PDI is measured in accordance with the protocol set forth in Example 2, below.

In some embodiments, the protein-enriched white flakes provided herein have a PDI of at least about 20, at least about 30, at least about 40, at least about 50, at least about 60, at least about 65, at least about 70, at least about 75, at least about 80, or at least about 90. In some embodiments, the protein-enriched white flakes provided herein have a protein content of at least about 65% on a dry weight basis, and PDI of at least about 20, at least about 30, at least about 40, at least about 50, at least about 60, at least about 65, at least about 70, at least about 75, at least about 80, or at least about 90.

In some embodiments, the protein-enriched white flakes provided herein have at least one of the following properties: improved characteristics selected from increased protein solubility at pH 7, increased foaming capacity, increased foaming stability, increased viscosity, increased water-holding capacity, increased oil-holding capacity, increased emulsification activity, increased emulsification stability, decreased emulsion droplet size, decreased minimum gelling concentration, increased gelling strength, or any combination thereof. In some embodiments, the protein-enriched white flakes have any combinations of the above. In some embodiments, the protein-enriched white flakes have all of the above. In some embodiments, the improved characteristics as described above are improved as compared to the same properties of protein-enriched white flakes obtained by methods employing carbohydrate extraction methods after defatting and desolventization.

### Environmental Profile

In some embodiments, the protein-enriched white flakes provided herein have a more favorable environmental profile as compared to white flakes prepared using commodity soybeans.

In some embodiments, having a favorable environmental comprises having a lower carbon footprint, requiring fewer resources to produce, and/or requiring less electricity to produce. In some embodiments, the carbon footprint of a white flake reflects the total amount of carbon dioxide released into the atmosphere as a result of the processing of soybeans to produce the white flake. In some embodiments, the carbon footprint of a white flake reflects the total amount of carbon dioxide released into the atmosphere as a result of the cultivation, harvesting, transport, and processing of soybeans to produce the white flake. In some embodiments, the carbon footprint of soybean cultivation includes emissions on field (e.g., emissions related to the use of lime or manure), diesel use in agricultural machinery, and production of pesticides and synthetic fertilizers. In some embodiments, the carbon footprint of soybean harvesting includes emissions from agricultural machinery and vehicles used to harvest the soybeans. In some embodiments, the carbon footprint of soybean transportation includes emissions from any vehicles used to transport the soybeans from the harvesting location to one or more processing locations. In some embodiments, the carbon footprint of processing the soybeans includes emissions associated with the generation of any heat used during processing (e.g., emissions from natural gas use), emissions from any electricity used during processing, and emissions associated with the production of any additives used during processing (e.g., emissions associated with the production of hexane used during processing).

In some embodiments, the protein-enriched white flakes provided herein have a lower carbon footprint as compared to white flakes prepared using commodity soybeans. In some embodiments, the total amount of carbon dioxide released into the atmosphere as a result of the processing of the soybeans to produce the protein-enriched white flakes is less than about 0.1, less than about 0.09, less than about 0.08, less than about 0.07, less than about 0.06, less than about 0.05, less than about 0.04, less than about 0.03, less than about 0.02, or less than about 0.01 tons of carbon dioxide per ton of white flake. In some embodiments, the total amount of carbon dioxide released into the atmosphere as a result of the processing of the soybeans to produce the protein-enriched white flakes is less than about 0.06 tons of carbon dioxide per ton of white flake. In some embodiments, the total amount of carbon dioxide released into the atmosphere as a result of the cultivation, harvesting, transport, and processing of soybeans to produce the protein-enriched white flakes is less than about 1, less than about 0.9, less than about 0.8, less than about 0.7, less than about 0.6, less than about 0.5, less than about 0.4, less than about 0.3, less than about 0.2, less than about 0.1, less than about 0.05, or less than about 0.03 tons of carbon dioxide per ton of protein-enriched white flakes produced. In some embodiments, the total amount of carbon dioxide released into the atmosphere as a result of the cultivation, harvesting, transport, and processing of soybeans to produce the protein-enriched white flakes is less than about 0.2 tons of carbon dioxide per ton of protein-enriched white flakes produced. In some embodiments, the total amount of carbon dioxide released into the atmosphere as a result of the cultivation, harvesting, transport, and processing of soybeans to produce the protein-enriched white flakes is at least about 70%, at least about 65%, at least about 60%, at least about 55%, at least about 50%, at least about 45%, at least about 40%, at least about 35%, at least about 30%, at least about 25%, at least about 20%, at least about 15%, or at least about 10% less carbon dioxide than would be released during an analogous process to produce white flakes from commodity soybeans. In some embodiments, the total amount of carbon dioxide released into the atmosphere as a result of the cultivation, harvesting, transport, and processing of soybeans to produce the protein-enriched white flakes is about 70%, about 65%, about 60%, about 55%, about 50%, about 45%, about 40%, about 35%, about 30%, about 25%, about 20%, about 15%, or about 10% less carbon dioxide than would be released during an analogous process to produce white flakes from commodity soybeans. In some embodiments, the total amount of carbon dioxide released into the atmosphere as a result of the cultivation, harvesting, transport, and processing of soybeans to produce the protein-enriched white flakes is at least about 60% less carbon dioxide than would be released during an analogous process to produce white flakes from commodity soybeans.

In some embodiments, the protein-enriched white flakes provided herein have a higher protein content and a similar carbon footprint as compared to a white flake prepared using commodity soybeans. In some embodiments, the protein-enriched white flakes have about 50% more, about 40% more, about 30% more, about 25% more, about 20% more, about 15% more, about 10% more, or about 5% more protein than a white flake with a similar carbon footprint prepared using commodity soybeans. In some embodiments, the protein-enriched white flakes have about 15% more protein than a white flake with a similar carbon footprint prepared using commodity soybeans.

In some embodiments, the protein-enriched white flakes provided herein have a lower carbon footprint than a soy composition with the same protein content prepared using commodity soybeans.

In some embodiments, the protein-enriched white flakes provided herein have a lower carbon footprint on a per-protein-weight basis as compared to a white flake prepared using commodity soybeans. In some embodiments, the total amount of carbon dioxide released into the atmosphere as a result of the processing of the soybeans to produce the protein-enriched white flakes is less than about 0.5, less than about 0.4, less than about 0.3, less than about 0.2, less than about 0.1, less than about 0.05, or less than about 0.03 tons of carbon dioxide per ton of soy protein. In some embodiments, the total amount of carbon dioxide released into the atmosphere as a result of the processing of the soybeans to produce the protein-enriched white flakes is less than about 0.1 tons of carbon dioxide per ton of soy protein. In some embodiments, the total amount of carbon dioxide released into the atmosphere as a result of the cultivation, harvesting, transport, and processing of soybeans to produce the protein-enriched white flakes is less than about 1.0, less than about 0.9, less than about 0.8, less than about 0.7, less than about 0.6, less than about 0.5, less than about 0.4, less than about 0.3, less than about 0.2, or less than about 0.1 tons of carbon dioxide per ton of soy protein. In some embodiments, the total amount of carbon dioxide released into the atmosphere as a result of the cultivation, harvesting, transport, and processing of soybeans to produce the protein-enriched white flakes is less than about 0.4 tons of carbon dioxide per ton of soy protein.

In some embodiments, the protein-enriched white flakes provided herein require less water to produce than white flakes prepared using commodity soybeans. In some embodiments, the protein-enriched white flakes are prepared using a process that uses less than about 1000 kg, less than about 900 kg, less than about 800 kg, less than about 700 kg, less than about 600 kg, less than about 500 kg, less than about 400 kg, less than about 300 kg, less than about 200 kg, or less than about 100 kg of water per ton of protein-enriched white flakes produced. In some embodiments, the protein-enriched white flakes are prepared using a process that uses less than about 500 kg of water per ton of protein-enriched white flakes produced.

In some embodiments, the protein-enriched white flakes provided herein have a higher protein content and require a similar amount of water to produce as compared to a white flake prepared using commodity soybeans. In some embodiments, the protein-enriched white flakes have about 50% more, about 40% more, about 30% more, about 25% more, about 20% more, about 15% more, about 10% more, or about 5% more protein than a white flake prepared using commodity soybeans that requires a similar amount of water to produce. In some embodiments, the protein-enriched white flakes have about 15% more protein than a white flake prepared using commodity soybeans that requires a similar amount of water to produce.

In some embodiments, the protein-enriched white flakes provided herein require less water to produce than a soy composition with the same protein content prepared using commodity soybeans.

In some embodiments, the protein-enriched white flakes provided herein require less water to produce on a per-protein-weight basis than a white flake prepared using commodity soybeans. In some embodiments, the total amount of water used in the processing of the soybeans to produce the protein-enriched white flakes is less than about 1500 kg, less than about 1400 kg, less than about 1300 kg, less than about 1200 kg, less than about 1100 kg, less than about 1000 kg, less than about 900 kg, less than about 800 kg, less than about 700 kg, or less than about 600 kg of water per ton of soy protein. In some embodiments, the total amount of water used in the processing of the soybeans to produce the protein-enriched white flakes is less than about 900 kg per ton of soy protein.

In some embodiments, the protein-enriched white flakes provided herein require less electricity to produce as compared to white flakes prepared using commodity soybeans. In some embodiments, the protein-enriched white flakes are prepared using a process that uses less than about 500 kWh, less than about 400 kWh, less than about 300 kWh, less than about 200 kWh, less than about 100 kWh, less than about 50 kWh, or less than about 25 kWh of electricity per ton or protein-enriched white flakes produced. In some embodiments, the protein-enriched white flakes are prepared using a process that uses less than about 100 kWh of electricity per ton or protein-enriched white flakes produced.

In some embodiments, the protein-enriched white flakes provided herein have a higher protein content and require a similar amount of electricity to produce as compared to a white flake prepared using commodity soybeans. In some embodiments, the protein-enriched white flakes have about 50% more, about 40% more, about 30% more, about 25% more, about 20% more, about 15% more, about 10% more, or about 5% more protein than a white flake prepared using commodity soybeans that requires a similar amount of electricity to produce. In some embodiments, the protein-enriched white flakes have about 15% more protein than a white flake prepared using commodity soybeans that requires a similar amount of electricity to produce.

In some embodiments, the protein-enriched white flakes provided herein require less electricity to produce than a soy composition with the same protein content prepared using commodity soybeans.

In some embodiments, the protein-enriched white flakes provided herein require less electricity to produce on a per-protein-weight basis than a white flake prepared using commodity soybeans. In some embodiments, the total amount of electricity used in the processing of the soybeans to produce the protein-enriched white flakes is less than about 200 kWh, less than about 190 kWh, less than about 180 kWh, less than about 170 kWh, less than about 160 kWh, less than about 150 kWh, or less than about 140 kWh of electricity per ton of soy protein. In some embodiments, the total amount of electricity used in the processing of the soybeans to produce the protein-enriched white flakes is less than about 170 kWh of electricity per ton of soy protein.

### II. Protein-Enriched Soy Flour

In one aspect, provided herein is a protein-enriched soy flour. In one aspect, provided herein are protein-enriched soy flour comprising at least about 60% soy protein on a dry weight basis. In one aspect, provided herein is a protein-enriched soy flour obtainable or produced by the methods according to the present disclosure.

In some embodiments, provided is a protein-enriched soy flour comprising at least about 60% protein and at least about 4% sugars on a dry weight basis.

Protein-enriched soy flour compositions may be produced by grinding protein-enhanced white flakes into a fine powder. This process is mechanical in nature, and does not substantially change the chemical composition of the white flakes. Accordingly, in some embodiments, provided is a protein-enriched soy flour with substantially the same chemical composition as the protein-enriched white flakes from which it is produced.

In some embodiments, the protein-enriched soy flour compositions may include any suitable grind of flour, grit, meal, or flake. In some embodiments, the protein-enriched soy flour compositions may include any suitable particle size. In some embodiments, the protein-enriched soy flour composition may comprise particles of a particular size, which may be separated using screening, milling, or any other method of separation.

It should be understood that in some embodiments, the protein-enriched soy flour disclosed herein may have a similar or identical composition as any of the protein-enriched white flakes disclosed in embodiments of this application. In some embodiments, the protein-enriched soy flour disclosed herein may have one or more similar or identical properties as any of the protein-enriched white flakes disclosed in embodiments of this application.

### Soy Protein Content

The protein-enriched soy flour provided herein has a high soy protein content, including relative to the soy protein content of the soybeans from which the enriched soy flour were obtained.

In some embodiments, the protein-enriched soy flour comprises at least about 60%, at least about 65%, at least about 70%, at least about 75%, at least about 80%, at least about 85%, or at least about 90% soy protein on a dry weight basis. In some embodiments, the protein-enriched soy flour comprises between about 60% and about 80%, between about 60% and about 75%, between about 60% and about 70%, between about 60% and about 65%, between about 65% and about 80%, between about 65% and about 75%, or between about 65% and about 70% soy protein on a dry weight basis.

In certain embodiments, the protein-enriched soy flour has at least about 1.1 times, at least about 1.2 times, at least about 1.25 times, at least about 1.3 times, at least about 1.35 times, at least about 1.4 times, at least about 1.5 times, at least about 1.7 times, or at least about 2 times more soy protein per unit weight than the soybeans from which the soy flour were obtained. In some embodiments, the protein-enriched soy flour comprises between about 1.2 and about 1.4 times more soy protein than the soybeans from which the enriched compositions were obtained.

### Fiber or Carbohydrate Content

In some embodiments, the protein-enriched soy flour provided herein has a higher carbohydrate content relative to soy protein concentrate (SPC) compositions with comparable protein compositions, obtained using a process comprising a carbohydrate extraction step.

It should also be recognized that the protein-enriched soy compositions of the present disclosure may comprise a particular profile of carbohydrates, including oligosaccharide content and soluble or insoluble fiber ratios, reflective of the methods of the present disclosure, which eschew any processing steps of removing carbohydrates in order to increase protein content. The carbohydrate and/or fiber composition of the protein-enriched soy compositions may distinguish the compositions from other commercially available soy products produced by methods involving removal of carbohydrates or from soy products prepared from blends of soy flours, soy protein concentrates, and/or soy protein isolates. It should be further recognized that the carbohydrate and/or fiber profiles of the protein-enriched soy compositions provided herein may contribute to their functional properties. In some embodiments, the protein-enriched soy flour is unblended, and is substantially free of soy protein concentrate or soy protein isolate.

In some such embodiments, the protein-enriched soy flour comprises at least about 4%, at least about 5%, at least about 6%, at least about 7%, at least about 8%, at least about 9%, or at least about 10% sugars on a dry weight basis. In some such embodiments, the protein-enriched soy flour comprises at least about 10% sugars on a dry weight basis. In some embodiments, the protein-enriched soy flour comprises at least about 4% sugars on a dry weight basis. In some embodiments, the protein-enriched soy flour comprises at least about 4% sugars, and at least about 60% soy protein on a dry weight basis. In some embodiments, the protein-enriched soy flour comprises at least about 4% sugars, and at least about 65% soy protein on a dry weight basis. In some embodiments, the sugars are present in the soybeans from which the protein-enriched soy flour were obtained.

In some embodiments, the protein-enriched soy flour may be characterized by the content of certain oligosaccharides, including but not limited to sucrose, stachyose, and raffinose, which contribute to the total sugar content.

In some embodiments, the protein-enriched soy flour provided herein has a stachyose content of less than or equal to about 10%, less than or equal to about 9%, less than or equal to about 8%, less than or equal to about 7.5%, less than or equal to about 7%, less than or equal to about 6%, less than or equal to about 5%, less than or equal to about 4%, or less than or equal to about 2% on a dry weight basis. In some embodiments, the protein-enriched soy flour provided herein has a raffinose content of less than or equal to about 5%, less than or equal to about 4.5%, less than or equal to about 4%, less than or equal to about 3.5%, less than or equal to about 3%, less than or equal to about 2.5%, less than or equal to about 2%, less than or equal to about 1.5%, or less than or equal to about 1% on a dry weight basis.

In some embodiments, the protein-enriched soy flour has at least about 0.1%, at least about 0.2%, at least about 0.3%, at least about 0.4%, at least about 0.5%, at least about 0.7%, at least about 1%, at least about 1.5%, at least about 2%, at least about 2.5%, at least about 3%, at least about 4%, at least about 5%, at least about 6%, at least about 8%, or at least about 10% raffinose on a dry weight basis. In some embodiments, the protein-enriched soy flour has at least about 0.5%, at least about 0.6% at least about 0.7%, at least about 0.8%, at least about 0.9%, at least about 1%, at least about 1.5%, at least about 2%, at least about 3%, at least about 4%, at least about 5%, at least about 6%, at least about 7%, at least about 8%, at least about 9%, at least about 10%, at least about 12%, or at least about 14% stachyose on a dry weight basis. In some embodiments, the protein-enriched soy flour has at least about 2%, at least about 3%, at least about 4%, at least about 5%, at least about 6%, at least about 7%, at least about 8%, at least about 9%, at least about 10%, at least about 12%, or at least about 14% sucrose on a dry weight basis.

In some embodiments, the protein-enriched soy flour provided herein has a lower concentration of undesirable oligosaccharides relative to soy flour produced by defatting and desolventizing soybeans that has a protein content of less than or equal to about 45% on a dry weight basis. For example, high protein soybeans having low concentrations of raffinose and stachyose may be employed by the methods as described herein to provide soy protein compositions having high protein as well as low concentrations of raffinose and stachyose, despite the omission of a carbohydrate extraction step after defatting and desolventization. In some embodiments wherein the protein-enriched soy flour provided herein are obtained from soybeans having low raffinose and/or stachyose content, the raffinose and/or stachyose content of the resulting soy flour may also be similarly low. In some embodiments, wherein the protein-enriched soy flour provided herein are obtained from soybeans having low raffinose and/or stachyose content as described herein, the protein-enriched soy flour has a stachyose content of at least about 0.5%, at least about 0.6% at least about 0.7%, at least about 0.8%, at least about 0.9%, at least about 1% on a dry weight basis. In some embodiments, wherein the protein-enriched soy flour provided herein are obtained from soybeans having low raffinose and/or raffinose content as described herein, the protein-enriched soy flour has a raffinose content of at least about 0.1%, at least about 0.2%, at least about 0.3%, at least about 0.4%, at least about 0.5%.

In some embodiments, the protein-enriched soy flour has at least about 0.1% or at least about 0.2% raffinose on a dry weight basis. In some embodiments, the protein-enriched soy flour has at least about 0.5% or at least about 1% stachyose on a dry weight basis. In other embodiments, the protein-enriched soy flour has (i) at least about 0.1% raffinose on a dry weight basis; (ii) at least about 0.5% stachyose on a dry weight basis, or (iii) a combination of at least about 0.1% raffinose and at least about 0.5% stachyose on a dry weight basis. In other embodiments, the protein-enriched soy flour has (i) at least about 0.2% raffinose on a dry weight basis; (ii) at least about 1% stachyose on a dry weight basis, or (iii) a combination of at least about 0.2% raffinose and at least about 1% stachyose on a dry weight basis.

In some embodiments, the protein-enriched soy flour provided herein has a lower carbohydrate content relative to soy flour produced by defatting and desolventizing soybeans that have a protein content of less than 45% on a dry weight basis.

In some embodiments, the protein-enriched soy flour provided herein has a total dietary fiber of less than or equal to about 30%, less than or equal to about 25%, less than or equal to about 22%, less than or equal to about 20%, less than or equal to about 18%, less than or equal to about 16%, less than or equal to about 14%, less than or equal to about 12%, or less than or equal to about 10% total dietary fiber on a dry weight basis. In some embodiments, the protein-enriched soy flour provided herein has a total dietary fiber of less than or equal to about 20%.

In some embodiments, the protein-enriched soy flour of the present disclosure has at least about 2%, at least about 5%, at least about 10%, at least about 15%, or at least about 20% soluble fiber on a dry weight basis. In other embodiments, protein-enriched soy flour of the present disclosure has at least about 2%, at least about 5%, at least about 10%, at least about 15%, or at least about 20% insoluble fiber on a dry weight basis.

### Fat Content

In some embodiments, the protein-enriched soy flour provided herein has a crude fat composition of less than or equal to about 3%, less than or equal to about 2%, or less than or equal to about 1% on a dry weight basis. In some embodiments, the protein-enriched soy flour provided herein has less than or equal to about 3% on a dry weight basis.

In some embodiments, the protein-enriched soy flour provided herein has a fat composition of less than or equal to about 5%, less than or equal to about 4%, less than or equal to about 3%, less than or equal to about 2%, or less than or equal to about 1% on a dry weight basis (as determined by acid hydrolysis). In some embodiments, the protein-enriched soy flour provided herein has less than or equal to about 5% on a dry weight basis (as determined by acid hydrolysis)

### Ash and Moisture Content

In some embodiments, the protein-enriched soy flour has less than or equal to about 7%, less than or equal to about 6%, less than or equal to about 5%, or less than or equal to about 4% ash on a dry weight basis. In some embodiments, the protein-enriched soy flour has less than or equal to about 7% ash on a dry weight basis.

In some embodiments, the protein-enriched soy flour has less than or equal to about 12%, less than or equal to about 11%, less than or equal to about 10%, less than or equal to about 9%, less than or equal to about 8%, or less than or equal to about 7% moisture on a dry weight basis. In some embodiments, the protein-enriched soy flour has less than or equal to about 12% moisture on a dry weight basis.

### Other Components

In some embodiments, the protein-enriched soy flour has at least one of the following properties: improved characteristics selected from improved average ratio of 11S soy protein (glycinin) to 7S soy protein (B-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof. In some embodiments, the protein-enriched soy flour has any combinations of the above. In some embodiments, the protein-enriched soy flour has all of the above. In some embodiments, the improved characteristics as described above are improved as compared to the same properties of soy flour obtained by methods employing carbohydrate extraction methods after defatting and desolventization.

In some embodiments, the protein-enriched soy flour provided herein has a higher concentration of certain compounds and relative to soy protein concentrate (SPC) compositions with comparable protein compositions, obtained using an alcohol extraction step.

In some embodiments, the protein-enriched soy flour has at least about 1%, at least about 2%, at least about 3%, at least about 4%, at least about 5%, at least about 6%, at least about 7%, at least about 8%, at least about 9%, at least about 10%, at least about 12%, or at least about 14% saponins on a dry weight basis.

In some embodiments, the protein-enriched soy flour provided herein has a concentration of B-conglycinin (7S soy protein) of at least about 50 mg/g. In some embodiments, the protein-enriched soy flour provided herein has at least about 10 ppm glycinin (11S soy protein). In some embodiments, the protein-enriched soy flour provided herein has at least about 10 ppm of lectins. In some embodiments, the protein-enriched soy flour provided herein has less than or equal to 20 mg isoflavones per 100 g protein-enriched white flake.

In some embodiments, the protein-enriched soy flour comprises one or more of the following: (i) at least about 1% saponins on a dry weight basis, (ii) at least about 50 mg/g of β-conglycinin (7S soy protein) on a dry weight basis, (iii) at least about 10 ppm glycinin (11S soy protein) antigen, (iv) at least about 10 ppm of lectins, or (v) less than or equal to 20 mg isoflavones per 100 gram protein-enriched soy ingredient. In some embodiments, the protein-enriched soy flour comprises any combination of (i)-(v). In some embodiments, the protein-enriched soy flour comprises any combination of (i)-(v). In some embodiments, the protein-enriched soy flour comprises all of (i)-(v). In some embodiments, the protein-enriched soy flour comprises all of (i)-(v).

### Functional Properties

Similar to the protein-enriched white flakes as described above, in some embodiments, the protein-enriched soy flour of the present disclosure may be characterized by various functional properties according to methods known in the art or according to any of the protocols as described herein. In some embodiments, the protein-enriched soy flour of the present disclosure may be characterized by any one of the following functional properties: protein dispersibility index (PDI), protein solubility, foaming capacity, foaming stability, viscosity, water holding capacity, oil holding capacity, emulsification activity, emulsification stability, median emulsion droplet size, minimum gelling concentration, gelling strength, bulk density, and/or texture properties. In some embodiments, the functional properties of the protein-enriched soy compositions, including the protein-enriched white flakes, protein-enriched soy flours, and protein-enriched texturized soy flours described herein may be evaluated by methods known in the art and/or methods as described herein, such as in Example 2.

In some embodiments, the protein-enriched soy flour provided herein has a higher protein dispersibility index (PDI), relative to soy protein concentrate (SPC) compositions with comparable protein compositions, obtained using a process comprising an alcohol extraction step. The compositions and methods of the present disclosure achieve higher protein dispersibility index values by virtue of the higher initial protein content of the originating soybeans from which the compositions are obtained in combination with processing methods that exclude a step to remove soluble matter (such as sugars) from the compositions, to achieve higher protein content.

PDI may be measured using any suitable techniques known in the art. For example, in one variation, PDI is measured in accordance with the protocol set forth in Example 2, below.

In some embodiments, the protein-enriched soy flour provided herein has a PDI of at least about 20, at least about 30, at least about 40, at least about 50, at least about 60, at least about 65, at least about 70, at least about 75, at least about 80, or at least about 90. In some embodiments, the protein-enriched soy flour provided herein has a protein content of at least about 65% on a dry weight basis, and PDI of at least about 20, at least about 30, at least about 40, at least about 50, at least about 60, at least about 65, at least about 70, at least about 75, at least about 80, or at least about 90.

In some embodiments, the protein-enriched soy flour provided herein has at least one of the following properties: improved characteristics selected from increased protein solubility at pH 7, increased foaming capacity, increased foaming stability, increased viscosity, increased water-holding capacity, increased oil-holding capacity, increased emulsification activity, increased emulsification stability, decreased emulsion droplet size, decreased minimum gelling concentration, increased gelling strength, or any combination thereof. In some embodiments, the protein-enriched soy flour has any combinations of the above. In some embodiments, the protein-enriched soy flour has all of the above. In some embodiments, the improved characteristics as described above are improved as compared to the same properties of protein-enriched soy flour obtained by methods employing carbohydrate extraction methods after defatting and desolventization.

### Environmental Profile

In some embodiments, the protein-enriched soy flour provided herein has a more favorable environmental profile as compared to soy flour prepared using commodity soybeans.

In some embodiments, having a favorable environmental comprises having a lower carbon footprint, requiring fewer resources to produce, or requiring less electricity to produce. In some embodiments, the carbon footprint of a soy flour reflects the total amount of carbon dioxide released into the atmosphere as a result of the processing of soybeans to produce the soy flour. In some embodiments, the carbon footprint of a soy flour reflects the total amount of carbon dioxide released into the atmosphere as a result of the cultivation, harvesting, transport, and processing of soybeans to produce the soy flour. In some embodiments, the carbon footprint of soybean cultivation includes emissions on field (e.g., emissions related to the use of lime or manure), diesel use in agricultural machinery, and production of pesticides and synthetic fertilizers. In some embodiments, the carbon footprint of soybean harvesting includes emissions from agricultural machinery and vehicles used to harvest the soybeans. In some embodiments, the carbon footprint of soybean transportation includes emissions from any vehicles used to transport the soybeans from the harvesting location to one or more processing locations. In some embodiments, the carbon footprint of processing the soybeans includes emissions associated with the generation of any heat used during processing (e.g., emissions from natural gas use), emissions from any electricity used during processing, and emissions associated with the production of any additives used during processing (e.g., emissions associated with the production of hexane used during processing).

In some embodiments, the protein-enriched soy flour provided herein has a lower carbon footprint as compared to soy flour prepared using commodity soybeans. In some embodiments, the total amount of carbon dioxide released into the atmosphere as a result of the processing of the soybeans to produce the protein-enriched soy flour is less than about 0.1, less than about 0.09, less than about 0.08, less than about 0.07, less than about 0.06, less than about 0.05, less than about 0.04, less than about 0.03, less than about 0.02, or less than about 0.01 tons of carbon dioxide per ton of soy flour. In some embodiments, the total amount of carbon dioxide released into the atmosphere as a result of the processing of the soybeans to produce the protein-enriched soy flour is less than about 0.07 tons of carbon dioxide per ton of soy flour. In some embodiments, the total amount of carbon dioxide released into the atmosphere as a result of the cultivation, harvesting, transport, and processing of soybeans to produce the protein-enriched soy flour is less than about 1, less than about 0.9, less than about 0.8, less than about 0.7, less than about 0.6, less than about 0.5, less than about 0.4, less than about 0.3, less than about 0.2, less than about 0.1, less than about 0.05, or less than about 0.03 tons of carbon dioxide per ton of protein-enriched soy flour produced. In some embodiments, the total amount of carbon dioxide released into the atmosphere as a result of the cultivation, harvesting, transport, and processing of soybeans to produce the protein-enriched soy flour is less than about 0.2 tons of carbon dioxide per ton of protein-enriched soy flour produced. In some embodiments, the total amount of carbon dioxide released into the atmosphere as a result of the cultivation, harvesting, transport, and processing of soybeans to produce the protein-enriched soy flour is at least about 70%, at least about 65%, at least about 60%, at least about 55%, at least about 50%, at least about 45%, at least about 40%, at least about 35%, at least about 30%, at least about 25%, at least about 20%, at least about 15%, or at least about 10% less carbon dioxide than would be released during an analogous process to produce soy flour from commodity soybeans. In some embodiments, the total amount of carbon dioxide released into the atmosphere as a result of the cultivation, harvesting, transport, and processing of soybeans to produce the protein-enriched soy flour is about 70%, about 65%, about 60%, about 55%, about 50%, about 45%, about 40%, about 35%, about 30%, about 25%, about 20%, about 15%, or about 10% less carbon dioxide than would be released during an analogous process to produce soy flour from commodity soybeans. In some embodiments, the total amount of carbon dioxide released into the atmosphere as a result of the cultivation, harvesting, transport, and processing of soybeans to produce the protein-enriched soy flour is at least about 60% less carbon dioxide than would be released during an analogous process to produce soy flour from commodity soybeans.

In some embodiments, the protein-enriched soy flour provided herein has a higher protein content and a similar carbon footprint as compared to a soy flour prepared using commodity soybeans. In some embodiments, the protein-enriched soy flour has about 50% more, about 40% more, about 30% more, about 25% more, about 20% more, about 15% more, about 10% more, or about 5% more protein than a soy flour with a similar carbon footprint prepared using commodity soybeans. In some embodiments, the protein-enriched soy flour has about 15% more protein than a soy flour with a similar carbon footprint prepared using commodity soybeans.

In some embodiments, the protein-enriched soy flour provided herein has a lower carbon footprint than a soy composition with the same protein content prepared using commodity soybeans.

In some embodiments, the protein-enriched soy flour provided herein has a lower carbon footprint on a per-protein-weight basis as compared to a soy flour prepared using commodity soybeans. In some embodiments, the total amount of carbon dioxide released into the atmosphere as a result of the processing of the soybeans to produce the protein-enriched soy flour is less than about 0.5, less than about 0.4, less than about 0.3, less than about 0.2, less than about 0.1, less than about 0.05, or less than about 0.03 tons of carbon dioxide per ton of soy protein. In some embodiments, the total amount of carbon dioxide released into the atmosphere as a result of the processing of the soybeans to produce the protein-enriched soy flour is less than about 0.2 tons of carbon dioxide per ton of soy protein. In some embodiments, the total amount of carbon dioxide released into the atmosphere as a result of the cultivation, harvesting, transport, and processing of soybeans to produce the protein-enriched soy flour is less than about 1.0, less than about 0.9, less than about 0.8, less than about 0.7, less than about 0.6, less than about 0.5, less than about 0.4, less than about 0.3, less than about 0.2, or less than about 0.1 tons of carbon dioxide per ton of soy protein. In some embodiments, the total amount of carbon dioxide released into the atmosphere as a result of the cultivation, harvesting, transport, and processing of soybeans to produce the protein-enriched soy flour is less than about 0.4 tons of carbon dioxide per ton of soy protein.

In some embodiments, the protein-enriched soy flour provided herein requires less water to produce than soy flour prepared using commodity soybeans. In some embodiments, the protein-enriched soy flour is prepared using a process that uses less than about 1000 kg, less than about 900 kg, less than about 800 kg, less than about 700 kg, less than about 600 kg, less than about 500 kg, less than about 400 kg, less than about 300 kg, less than about 200 kg, or less than about 100 kg of water per ton of protein-enriched soy flour produced. In some embodiments, the protein-enriched soy flour is prepared using a process that uses less than about 500 kg of water per ton of protein-enriched soy flour produced.

In some embodiments, the protein-enriched soy flour provided herein has a higher protein content and require a similar amount of water to produce as compared to a soy flour prepared using commodity soybeans. In some embodiments, the protein-enriched soy flour has about 50% more, about 40% more, about 30% more, about 25% more, about 20% more, about 15% more, about 10% more, or about 5% more protein than a soy flour prepared using commodity soybeans that requires a similar amount of water to produce. In some embodiments, the protein-enriched soy flour has about 15% more protein than a soy flour prepared using commodity soybeans that requires a similar amount of water to produce.

In some embodiments, the protein-enriched soy flour provided herein requires less water to produce than a soy composition with the same protein content prepared using commodity soybeans.

In some embodiments, the protein-enriched soy flour provided herein requires less water to produce on a per-protein-weight basis than a soy flour prepared using commodity soybeans. In some embodiments, the total amount of water used in the processing of the soybeans to produce the protein-enriched soy flour is less than about 1500 kg, less than about 1400 kg, less than about 1300 kg, less than about 1200 kg, less than about 1100 kg, less than about 1000 kg, less than about 900 kg, less than about 800 kg, less than about 700 kg, or less than about 600 kg of water per ton of soy protein. In some embodiments, the total amount of water used in the processing of the soybeans to produce the protein-enriched soy flour is less than about 900 kg per ton of soy protein.

In some embodiments, the protein-enriched soy flour provided herein requires less electricity to produce as compared to soy flour prepared using commodity soybeans. In some embodiments, the protein-enriched soy flour is prepared using a process that uses less than about 500 kWh, less than about 400 kWh, less than about 300 kWh, less than about 200 kWh, less than about 150 kWh, less than about 100 kWh, or less than about 50 kWh of electricity per ton or protein-enriched soy flour produced. In some embodiments, the protein-enriched soy flour is prepared using a process that uses less than about 150 kWh of electricity per ton or protein-enriched soy flour produced.

In some embodiments, the protein-enriched soy flour provided herein has a higher protein content and require a similar amount of electricity to produce as compared to a soy flour prepared using commodity soybeans. In some embodiments, the protein-enriched soy flour has about 50% more, about 40% more, about 30% more, about 25% more, about 20% more, about 15% more, about 10% more, or about 5% more protein than a soy flour prepared using commodity soybeans that requires a similar amount of electricity to produce. In some embodiments, the protein-enriched soy flour has about 15% more protein than a soy flour prepared using commodity soybeans that requires a similar amount of electricity to produce.

In some embodiments, the protein-enriched soy flour provided herein requires less electricity to produce than a soy composition with the same protein content prepared using commodity soybeans.

In some embodiments, the protein-enriched soy flour provided herein requires less electricity to produce on a per-protein-weight basis than a soy flour prepared using commodity soybeans. In some embodiments, the total amount of electricity used in the processing of the soybeans to produce the protein-enriched soy flour is less than about 300 kWh, less than about 290 kWh, less than about 280 kWh, less than about 270 kWh, less than about 260 kWh, less than about 250 kWh, or less than about 240 kWh of electricity per ton of soy protein. In some embodiments, the total amount of electricity used in the processing of the soybeans to produce the protein-enriched soy flour is less than about 260 kWh of electricity per ton of soy protein.

### III. Texturized Soy Flour

In one aspect, provided herein is a protein-enriched texturized soy flour. In one aspect, provided herein are protein-enriched texturized soy flour comprising at least about 60% soy protein on a dry weight basis. In one aspect, provided herein is a protein-enriched texturized soy flour obtainable or produced by the methods according to the present disclosure.

In some embodiments, provided is a protein-enriched texturized soy flour comprising at least about 60% protein and at least about 4% sugars on a dry weight basis.

Protein-enriched texturized soy flour compositions may be produced by extruding protein-enhanced soy flours. This process is mechanical in nature, and does not substantially change the chemical composition of the soy flour, but may alter the functional properties of the soy flour. Accordingly, in some embodiments, provided is a protein-enriched texturized soy flour with substantially the same chemical composition as the protein-enriched soy flour from which it is produced. In other embodiments, provided is a protein-enriched texturized soy flour with functional properties which may be the same or different as the functional properties of the protein-enriched soy flour from which it is produced.

### Soy Protein Content

The protein-enriched texturized soy flour provided herein has a high soy protein content, including relative to the soy protein content of the soybeans from which the enriched texturized soy flour were obtained.

In some embodiments, the protein-enriched texturized soy flour comprises at least about 60%, at least about 65%, at least about 70%, at least about 75%, at least about 80%, at least about 85%, or at least about 90% soy protein on a dry weight basis. In some embodiments, the protein-enriched texturized soy flour comprises between about 60% and about 80%, between about 60% and about 75%, between about 60% and about 70%, between about 60% and about 65%, between about 65% and about 80%, between about 65% and about 75%, or between about 65% and about 70% soy protein on a dry weight basis.

In certain embodiments, the protein-enriched texturized soy flour has at least about 1.1 times, at least about 1.2 times, at least about 1.25 times, at least about 1.3 times, at least about 1.35 times, at least about 1.4 times, at least about 1.5 times, at least about 1.7 times, or at least about 2 times more soy protein per unit weight than the soybeans from which the texturized soy flour were obtained. In some embodiments, the protein-enriched texturized soy flour comprises between about 1.2 and about 1.4 times more soy protein than the soybeans from which the enriched compositions were obtained.

### Fiber or Carbohydrate Content

In some embodiments, the protein-enriched texturized soy flour provided herein has a higher carbohydrate content relative to soy protein concentrate (SPC) compositions with comparable protein compositions, obtained using a process comprising a carbohydrate extraction step.

It should also be recognized that the protein-enriched soy compositions of the present disclosure may comprise a particular profile of carbohydrates, including oligosaccharide content and soluble or insoluble fiber ratios, reflective of the methods of the present disclosure, which eschew any processing steps of removing carbohydrates in order to increase protein content. The carbohydrate and/or fiber composition of the protein-enriched soy compositions may distinguish the compositions from other commercially available soy products produced by methods involving removal of carbohydrates or from soy products prepared from blends of texturized soy flours, soy protein concentrates, and/or soy protein isolates. It should be further recognized that the carbohydrate and/or fiber profiles of the protein-enriched soy compositions provided herein may contribute to their functional properties. In some embodiments, the protein-enriched texturized soy flour is unblended, and is substantially free of soy protein concentrate or soy protein isolate.

In some such embodiments, the protein-enriched texturized soy flour comprises at least about 4%, at least about 5%, at least about 6%, at least about 7%, at least about 8%, at least about 9%, or at least about 10% sugars on a dry weight basis. In some such embodiments, the protein-enriched texturized soy flour comprises at least about 10% sugars on a dry weight basis. In some embodiments, the protein-enriched texturized soy flour comprises at least about 4% sugars on a dry weight basis. In some embodiments, the protein-enriched texturized soy flour comprises at least about 4% sugars, and at least about 60% soy protein on a dry weight basis. In some embodiments, the protein-enriched texturized soy flour comprises at least about 4% sugars, and at least about 65% soy protein on a dry weight basis. In some embodiments, the sugars are present in the soybeans from which the protein-enriched texturized soy flour was obtained.

In some embodiments, the protein-enriched texturized soy flour may be characterized by the content of certain oligosaccharides, including but not limited to sucrose, stachyose, and raffinose, which contribute to the total sugar content.

In some embodiments, the protein-enriched texturized soy flour provided herein has a stachyose content of less than or equal to about 10%, less than or equal to about 9%, less than or equal to about 8%, less than or equal to about 7.5%, less than or equal to about 7%, less than or equal to about 6%, less than or equal to about 5%, less than or equal to about 4%, or less than or equal to about 2% on a dry weight basis. In some embodiments, the protein-enriched texturized soy flour provided herein has a raffinose content of less than or equal to about 5%, less than or equal to about 4.5%, less than or equal to about 4%, less than or equal to about 3.5%, less than or equal to about 3%, less than or equal to about 2.5%, less than or equal to about 2%, less than or equal to about 1.5%, or less than or equal to about 1% on a dry weight basis.

In some embodiments, the protein-enriched texturized soy flour has at least about 0.1%, at least about 0.2%, at least about 0.3%, at least about 0.4%, at least about 0.5%, at least about 0.7%, at least about 1%, at least about 1.5%, at least about 2%, at least about 2.5%, at least about 3%, at least about 4%, at least about 5%, at least about 6%, at least about 8%, or at least about 10% raffinose on a dry weight basis. In some embodiments, the protein-enriched texturized soy flour has at least about 0.5%, at least about 0.6% at least about 0.7%, at least about 0.8%, at least about 0.9%, at least about 1%, at least about 1.5%, at least about 2%, at least about 3%, at least about 4%, at least about 5%, at least about 6%, at least about 7%, at least about 8%, at least about 9%, at least about 10%, at least about 12%, or at least about 14% stachyose on a dry weight basis. In some embodiments, the protein-enriched texturized soy flour has at least about 2%, at least about 3%, at least about 4%, at least about 5%, at least about 6%, at least about 7%, at least about 8%, at least about 9%, at least about 10%, at least about 12%, or at least about 14% sucrose on a dry weight basis.

In some embodiments, the protein-enriched texturized soy flour provided herein has a lower concentration of undesirable oligosaccharides relative to texturized soy flour produced by defatting and desolventizing soybeans that has a protein content of less than or equal to about 45% on a dry weight basis. For example, high protein soybeans having low concentrations of raffinose and stachyose may be employed by the methods as described herein to provide soy protein compositions having high protein as well as low concentrations of raffinose and stachyose, despite the omission of a carbohydrate extraction step after defatting and desolventization. In some embodiments wherein the protein-enriched texturized soy flour provided herein are obtained from soybeans having low raffinose and/or stachyose content, the raffinose and/or stachyose content of the resulting texturized soy flour may also be similarly low. In some embodiments, wherein the protein-enriched texturized soy flour provided herein are obtained from soybeans having low raffinose and/or stachyose content as described herein, the protein-enriched texturized soy flour has a stachyose content of at least about 0.5%, at least about 0.6% at least about 0.7%, at least about 0.8%, at least about 0.9%, at least about 1% on a dry weight basis. In some embodiments, wherein the protein-enriched texturized soy flour provided herein are obtained from soybeans having low raffinose and/or raffinose content as described herein, the protein-enriched texturized soy flour has a raffinose content of at least about 0.1%, at least about 0.2%, at least about 0.3%, at least about 0.4%, at least about 0.5%.

In some embodiments, the protein-enriched texturized soy flour has at least about 0.1% or at least about 0.2% raffinose on a dry weight basis. In some embodiments, the protein-enriched texturized soy flour has at least about 0.5% or at least about 1% stachyose on a dry weight basis. In other embodiments, the protein-enriched texturized soy flour has (i) at least about 0.1% raffinose on a dry weight basis; (ii) at least about 0.5% stachyose on a dry weight basis, or (iii) a combination of at least about 0.1% raffinose and at least about 0.5% stachyose on a dry weight basis. In other embodiments, the protein-enriched texturized soy flour has (i) at least about 0.2% raffinose on a dry weight basis; (ii) at least about 1% stachyose on a dry weight basis, or (iii) a combination of at least about 0.2% raffinose and at least about 1% stachyose on a dry weight basis.

In some embodiments, the protein-enriched texturized soy flour provided herein has a lower carbohydrate content relative to texturized soy flour produced by defatting and desolventizing soybeans that have a protein content of less than 45% on a dry weight basis.

In some embodiments, the protein-enriched texturized soy flour provided herein has a total dietary fiber of less than or equal to about 30%, less than or equal to about 25%, less than or equal to about 22%, less than or equal to about 20%, less than or equal to about 18%, less than or equal to about 16%, less than or equal to about 14%, less than or equal to about 12%, or less than or equal to about 10% total dietary fiber on a dry weight basis. In some embodiments, the protein-enriched texturized soy flour provided herein has a total dietary fiber of less than or equal to about 20%.

In some embodiments, the protein-enriched texturized soy flour of the present disclosure has at least about 2%, at least about 5%, at least about 10%, at least about 15%, or at least about 20% soluble fiber on a dry weight basis. In other embodiments, protein-enriched texturized soy flour of the present disclosure has at least about 2%, at least about 5%, at least about 10%, at least about 15%, or at least about 20% insoluble fiber on a dry weight basis.

### Fat Content

In some embodiments, the protein-enriched texturized soy flour provided herein has a crude fat composition of less than or equal to about 3%, less than or equal to about 2%, or less than or equal to about 1% on a dry weight basis. In some embodiments, the protein-enriched texturized soy flour provided herein has less than or equal to about 3% on a dry weight basis.

In some embodiments, the protein-enriched texturized soy flour provided herein has a fat composition of less than or equal to about 5%, less than or equal to about 4%, less than or equal to about 3%, less than or equal to about 2%, or less than or equal to about 1% on a dry weight basis (as determined by acid hydrolysis). In some embodiments, the protein-enriched texturized soy flour provided herein has less than or equal to about 5% on a dry weight basis (as determined by acid hydrolysis).

### Ash and Moisture Content

In some embodiments, the protein-enriched texturized soy flour has less than or equal to about 7%, less than or equal to about 6%, less than or equal to about 5%, or less than or equal to about 4% ash on a dry weight basis. In some embodiments, the protein-enriched texturized soy flour has less than or equal to about 7% ash on a dry weight basis.

In some embodiments, the protein-enriched texturized soy flour has less than or equal to about 12%, less than or equal to about 11%, less than or equal to about 10%, less than or equal to about 9%, less than or equal to about 8%, or less than or equal to about 7% moisture on a dry weight basis. In some embodiments, the protein-enriched texturized soy flour has less than or equal to about 12% moisture on a dry weight basis.

### Other Components

In some embodiments, the protein-enriched texturized soy flour has at least one of the following properties: improved characteristics selected from improved average ratio of 11S soy protein (glycinin) to 7S soy protein (B-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof. In some embodiments, the protein-enriched texturized soy flour has any combinations of the above. In some embodiments, the protein-enriched texturized soy flour has all of the above. In some embodiments, the improved characteristics as described above are improved as compared to the same properties of texturized soy flour obtained by methods employing carbohydrate extraction methods after defatting and desolventization.

In some embodiments, the protein-enriched texturized soy flour provided herein has a higher concentration of certain compounds and relative to soy protein concentrate (SPC) compositions with comparable protein compositions, obtained using an alcohol extraction step.

In some embodiments, the protein-enriched texturized soy flour has at least about 1%, at least about 2%, at least about 3%, at least about 4%, at least about 5%, at least about 6%, at least about 7%, at least about 8%, at least about 9%, at least about 10%, at least about 12%, or at least about 14% saponins on a dry weight basis.

In some embodiments, the protein-enriched texturized soy flour provided herein has a concentration of B-conglycinin (7S soy protein) of at least about 50 mg/g. In some embodiments, the protein-enriched texturized soy flour provided herein has at least about 10 ppm glycinin (11S soy protein). In some embodiments, the protein-enriched texturized soy flour provided herein has at least about 10 ppm of lectins. In some embodiments, the protein-enriched texturized soy flour provided herein has less than or equal to 20 mg isoflavones per 100 g protein-enriched white flake.

In some embodiments, the protein-enriched texturized soy flour comprises one or more of the following: (i) at least about 1% saponins on a dry weight basis, (ii) at least about 50 mg/g of B-conglycinin (7S soy protein) on a dry weight basis, (iii) at least about 10 ppm glycinin (11S soy protein) antigen, (iv) at least about 10 ppm of lectins, or (v) less than or equal to 20 mg isoflavones per 100 gram protein-enriched soy ingredient. In some embodiments, the protein-enriched texturized soy flour comprises any combination of (i)-(v). In some embodiments, the protein-enriched texturized soy flour comprises any combination of (i)-(v). In some embodiments, the protein-enriched texturized soy flour comprises all of (i)-(v). In some embodiments, the protein-enriched texturized soy flour comprises all of (i)-(v).

### Functional Properties

Similar to the protein-enriched white flakes and soy flour as described above, in some embodiments, the protein-enriched texturized soy flour of the present disclosure may be characterized by various functional properties according to methods known in the art or according to any of the protocols as described herein. In some embodiments, the protein-enriched texturized soy flour of the present disclosure may be characterized by any one of the following functional properties: protein dispersibility index (PDI), protein solubility, foaming capacity, foaming stability, viscosity, water holding capacity, oil holding capacity, emulsification activity, emulsification stability, median emulsion droplet size, minimum gelling concentration, gelling strength, bulk density, and/or texture properties. In some embodiments, the functional properties of the protein-enriched soy compositions, including the protein-enriched white flakes, protein-enriched soy flours, and protein-enriched texturized soy flours described herein may be evaluated by methods known in the art and/or methods as described herein, such as in Example 2.

In some embodiments, the protein-enriched texturized soy flour provided herein has a higher protein dispersibility index (PDI), relative to soy protein concentrate (SPC) compositions with comparable protein compositions, obtained using a process comprising an alcohol extraction step. The compositions and methods of the present disclosure achieve higher protein dispersibility index values by virtue of the higher initial protein content of the originating soybeans from which the compositions are obtained in combination with processing methods that exclude a step to remove soluble matter (such as sugars) from the compositions, to achieve higher protein content.

PDI may be measured using any suitable techniques known in the art. For example, in one variation, PDI is measured in accordance with the protocol set forth in Example 2, below.

In some embodiments, the protein-enriched texturized soy flour provided herein has a PDI of at least about 20, at least about 30, at least about 40, at least about 50, at least about 60, at least about 65, at least about 70, at least about 75, at least about 80, or at least about 90. In some embodiments, the protein-enriched texturized soy flour provided herein has a protein content of at least about 65% on a dry weight basis, and PDI of at least about 20, at least about 30, at least about 40, at least about 50, at least about 60, at least about 65, at least about 70, at least about 75, at least about 80, or at least about 90.

In some embodiments, the protein-enriched textured soy flour provided herein has at least one of the following properties: improved characteristics selected from increased protein solubility at pH 7, increased foaming capacity, increased foaming stability, increased viscosity, increased water-holding capacity, increased oil-holding capacity, increased emulsification activity, increased emulsification stability, decreased emulsion droplet size, decreased minimum gelling concentration, increased gelling strength, or any combination thereof. In some embodiments, the protein-enriched textured soy flour has any combinations of the above. In some embodiments, the protein-enriched textured soy flour has all of the above. In some embodiments, the improved characteristics as described above are improved as compared to the same properties of protein-enriched textured soy flour obtained by methods employing carbohydrate extraction methods after defatting and desolventization.

### IV. Soybean Meal

In one aspect, provided herein is a protein-enriched soybean meal. In some embodiments, the protein-enriched soybean meal provided herein has a more favorable environmental profile as compared to soybean meal prepared using commodity soybeans.

In some embodiments, having a favorable environmental comprises having a lower carbon footprint, requiring fewer resources to produce, or requiring less electricity to produce. In some embodiments, the carbon footprint of a soybean meal reflects the total amount of carbon dioxide released into the atmosphere as a result of the processing of soybeans to produce the soybean meal. In some embodiments, the carbon footprint of a soybean meal reflects the total amount of carbon dioxide released into the atmosphere as a result of the cultivation, harvesting, transport, and processing of soybeans to produce the soybean meal. In some embodiments, the carbon footprint of soybean cultivation includes emissions on field (e.g., emissions related to the use of lime or manure), diesel use in agricultural machinery, and production of pesticides and synthetic fertilizers. In some embodiments, the carbon footprint of soybean harvesting includes emissions from agricultural machinery and vehicles used to harvest the soybeans. In some embodiments, the carbon footprint of soybean transportation includes emissions from any vehicles used to transport the soybeans from the harvesting location to one or more processing locations. In some embodiments, the carbon footprint of processing the soybeans includes emissions associated with the generation of any heat used during processing (e.g., emissions from natural gas use), emissions from any electricity used during processing, and emissions associated with the production of any additives used during processing (e.g., emissions associated with the production of hexane used during processing).

In some embodiments, the protein-enriched soybean meal provided herein has a lower carbon footprint as compared to soybean meal prepared using commodity soybeans. In some embodiments, the total amount of carbon dioxide released into the atmosphere as a result of the processing of the soybeans to produce the protein-enriched soybean meal is less than about 0.1, less than about 0.09, less than about 0.08, less than about 0.07, less than about 0.06, less than about 0.05, less than about 0.04, less than about 0.03, less than about 0.02, or less than about 0.01 tons of carbon dioxide per ton of soybean meal. In some embodiments, the total amount of carbon dioxide released into the atmosphere as a result of the processing of the soybeans to produce the protein-enriched soybean meal is less than about 0.06 tons of carbon dioxide per ton of soybean meal. In some embodiments, the total amount of carbon dioxide released into the atmosphere as a result of the cultivation, harvesting, transport, and processing of soybeans to produce the protein-enriched soybean meal is less than about 1, less than about 0.9, less than about 0.8, less than about 0.7, less than about 0.6, less than about 0.5, less than about 0.4, less than about 0.3, less than about 0.2, less than about 0.1, less than about 0.05, or less than about 0.03 tons of carbon dioxide per ton of protein-enriched soybean meal produced. In some embodiments, the total amount of carbon dioxide released into the atmosphere as a result of the cultivation, harvesting, transport, and processing of soybeans to produce the protein-enriched soybean meal is less than about 0.2 tons of carbon dioxide per ton of protein-enriched soybean meal produced.

In some embodiments, the protein-enriched soybean meal provided herein has a higher protein content and a similar carbon footprint as compared to a soybean meal prepared using commodity soybeans. In some embodiments, the protein-enriched soybean meal has about 50% more, about 40% more, about 30% more, about 25% more, about 20% more, about 15% more, about 10% more, or about 5% more protein than a soybean meal with a similar carbon footprint prepared using commodity soybeans. In some embodiments, the protein-enriched soybean meal has about 15% more protein than a soybean meal with a similar carbon footprint prepared using commodity soybeans.

In some embodiments, the protein-enriched soybean meal provided herein has a lower carbon footprint than a soy composition with the same protein content prepared using commodity soybeans.

In some embodiments, the protein-enriched soybean meal provided herein has a lower carbon footprint on a per-protein-weight basis as compared to a soybean meal prepared using commodity soybeans. In some embodiments, the total amount of carbon dioxide released into the atmosphere as a result of the processing of the soybeans to produce the protein-enriched soybean meal is less than about 0.5, less than about 0.4, less than about 0.3, less than about 0.2, less than about 0.1, less than about 0.05, or less than about 0.03 tons of carbon dioxide per ton of soy protein. In some embodiments, the total amount of carbon dioxide released into the atmosphere as a result of the processing of the soybeans to produce the protein-enriched soybean meal is less than about 0.1 tons of carbon dioxide per ton of soy protein. In some embodiments, the total amount of carbon dioxide released into the atmosphere as a result of the cultivation, harvesting, transport, and processing of soybeans to produce the protein-enriched soybean meal is less than about 1.0, less than about 0.9, less than about 0.8, less than about 0.7, less than about 0.6, less than about 0.5, less than about 0.4, less than about 0.3, less than about 0.2, or less than about 0.1 tons of carbon dioxide per ton of soy protein. In some embodiments, the total amount of carbon dioxide released into the atmosphere as a result of the cultivation, harvesting, transport, and processing of soybeans to produce the protein-enriched soybean meal is less than about 0.4 tons of carbon dioxide per ton of soy protein.

In some embodiments, the protein-enriched soybean meal provided herein requires less water to produce than soybean meal prepared using commodity soybeans. In some embodiments, the protein-enriched soybean meal is prepared using a process that uses less than about 1000 kg, less than about 900 kg, less than about 800 kg, less than about 700 kg, less than about 600 kg, less than about 500 kg, less than about 400 kg, less than about 300 kg, less than about 200 kg, or less than about 100 kg of water per ton of protein-enriched soybean meal produced. In some embodiments, the protein-enriched soybean meal is prepared using a process that uses less than about 500 kg of water per ton of protein-enriched soybean meal produced.

In some embodiments, the protein-enriched soybean meal provided herein has a higher protein content and require a similar amount of water to produce as compared to a soybean meal prepared using commodity soybeans. In some embodiments, the protein-enriched soybean meal has about 50% more, about 40% more, about 30% more, about 25% more, about 20% more, about 15% more, about 10% more, or about 5% more protein than a soybean meal prepared using commodity soybeans that requires a similar amount of water to produce. In some embodiments, the protein-enriched soybean meal has about 15% more protein than a soybean meal prepared using commodity soybeans that requires a similar amount of water to produce.

In some embodiments, the protein-enriched soybean meal provided herein requires less water to produce than a soy composition with the same protein content prepared using commodity soybeans.

In some embodiments, the protein-enriched soybean meal provided herein requires less water to produce on a per-protein-weight basis than a soybean meal prepared using commodity soybeans. In some embodiments, the total amount of water used in the processing of the soybeans to produce the protein-enriched soybean meal is less than about 1500 kg, less than about 1400 kg, less than about 1300 kg, less than about 1200 kg, less than about 1100 kg, less than about 1000 kg, less than about 900 kg, less than about 800 kg, less than about 700 kg, or less than about 600 kg of water per ton of soy protein. In some embodiments, the total amount of water used in the processing of the soybeans to produce the protein-enriched soybean meal is less than about 900 kg per ton of soy protein.

In some embodiments, the protein-enriched soybean meal provided herein requires less electricity to produce as compared to soybean meal prepared using commodity soybeans. In some embodiments, the protein-enriched soybean meal is prepared using a process that uses less than about 500 kWh, less than about 400 kWh, less than about 300 kWh, less than about 200 kWh, less than about 100 kWh, less than about 50 kWh, or less than about 25 kWh of electricity per ton or protein-enriched soybean meal produced. In some embodiments, the protein-enriched soybean meal is prepared using a process that uses less than about 100 kWh of electricity per ton or protein-enriched soybean meal produced.

In some embodiments, the protein-enriched soybean meal provided herein has a higher protein content and require a similar amount of electricity to produce as compared to a soybean meal prepared using commodity soybeans. In some embodiments, the protein-enriched soybean meal has about 50% more, about 40% more, about 30% more, about 25% more, about 20% more, about 15% more, about 10% more, or about 5% more protein than a soybean meal prepared using commodity soybeans that requires a similar amount of electricity to produce. In some embodiments, the protein-enriched soybean meal has about 15% more protein than a soybean meal prepared using commodity soybeans that requires a similar amount of electricity to produce.

In some embodiments, the protein-enriched soybean meal provided herein requires less electricity to produce than a soy composition with the same protein content prepared using commodity soybeans.

In some embodiments, the protein-enriched soybean meal provided herein requires less electricity to produce on a per-protein-weight basis than a soybean meal prepared using commodity soybeans. In some embodiments, the total amount of electricity used in the processing of the soybeans to produce the protein-enriched soybean meal is less than about 200 kWh, less than about 190 kWh, less than about 180 kWh, less than about 170 kWh, less than about 160 kWh, less than about 150 kWh, or less than about 140 kWh of electricity per ton of soy protein. In some embodiments, the total amount of electricity used in the processing of the soybeans to produce the protein-enriched soybean meal is less than about 170 kWh of electricity per ton of soy protein.

### D. Use of Compositions

The protein-enriched white flakes, soy flour and texturized soy flour as provided herein may exhibit one or more particular physicochemical properties or functionalities which makes these protein-enriched soy compositions especially suitable for certain uses, particularly use in food products.

In certain aspects, provided are also food and beverage products incorporating or produced using the protein-enriched soy compositions herein. Such protein-enriched soy compositions may be used for protein fortification in various food and beverage products, including for example, in juice based high acid beverages, allergen-free non-dairy low acid beverages, plant-based yogurts, plant-based ice-creams, bakery products, baked snacks, cream soups, meat analogs, and cheese analogs.

In some embodiments, suitable food products may include, for example, soups, sauces, salad dressings, hummus, breads, cookies, crackers, nutritional bars, meal replacement products, and snacks. In some variations, the food product incorporating or produced from the protein-enriched soy compositions herein is a bakery product.

In some embodiments, beverages may include, for example, high-acid beverages, neutral beverages, carbonated beverages, non-carbonated beverages, high protein beverages, and meal replacement beverages.

As described herein, the properties of the protein-enriched soy compositions may be used as ingredients in various food applications. The protein-enriched soy compositions, or ingredients, as provided herein possess a number of favorable properties in addition to their high protein content, which makes them suitable for a wide-array of food and beverage products. With respect to certain applications, the protein-enriched soy ingredients provided herein may demonstrate comparable and, in certain circumstances, superior properties as compared to other soy ingredients in the market, and thus may be advantageously incorporated into specific food products over competitor soy products. Exemplary products may include but are not limited to beverage products such as ready-to-drink beverages or protein shake powders, dairy product substitutes including plant-based yogurt, cheese or milks, meat substitute products such as plant-based burgers, and egg substitutes.

In some variations of the foregoing, the food or beverage products have at least about 1, at least about 2, at least about 3, at least about 4, at least about 5, at least about 6, at least about 7, at least about 8, at least about 9, at least about 10 grams, at least about 12 g, at least about 15 g, or at least about 17 g of soy protein per serving. In some variations, the food or beverage products have between about 1 g and about 20 g of soy protein per serving. In certain variations, at least about 10%, at least about 20%, at least about 25%, at least about 30%, at least about 40%, at least about 50%, at least about 60%, at least about 70%, at least about 75%, at least about 80%, at least about 90%, or at least about 95% by weight of the protein in the food or beverage product is from soy protein.

The food and beverages products can include various other components other than the protein-enriched soy compositions described herein. For example, the food and beverage products may include, for example, water, flour, fats and oils, sweeteners (such as sugar), salt, leavening agents, fruit and vegetable juices, thickeners (such as pectin and other hydro colloids), anti-foaming agents, natural and artificial flavorings, preservatives, and coloring agents.

In another aspect, provided is a method of preparing food and/or beverages products. Such methods may include one or more of mixing/blending, pasteurizing and/or sterilizing, baking, fermenting, carbonating, leavening, and packaging.

In other aspects, the protein-enriched soy compositions herein may be used as or incorporated into pharmaceutical products. In certain variations of the foregoing aspect, the protein-enriched soy compositions have a pharmaceutical-grade purity. In other variations, the protein-enriched soy compositions have a protein purity of greater than or equal to about 99%.

In other aspects, the protein-enriched soy compositions herein may be used as or incorporated into dietary supplement products. In certain variations of the foregoing aspect, the protein-enriched soy compositions have a dietary supplement-grade purity. In other variations, the protein-enriched soy compositions have a protein purity of greater than or equal to about 99%.

In other aspects, the protein-enriched soy compositions herein may be used as or incorporated into cosmetic products. In certain variations of the foregoing aspect, the protein-enriched soy compositions have a cosmetic-grade purity. In other variations, the protein-enriched soy compositions have a protein purity of greater than or equal to about 99%.

In other aspects, the protein-enriched soy compositions herein may be used as or incorporated into medical foods. In certain variations of the foregoing aspect, the protein-enriched soy compositions have a medical food-grade purity. In other variations, the protein-enriched soy compositions have a protein purity of greater than or equal to about 99%.

In other aspects, the protein-enriched soy compositions herein may be used as or incorporated into infant formula products. In certain variations of the foregoing aspect, the protein-enriched soy compositions have an infant formula-grade purity. In other variations, the protein-enriched soy compositions have a protein purity of greater than or equal to about 99%.

ENUMERATED EMBODIMENTS

The following enumerated embodiments are representative of some aspects of the invention.

Embodiment 1. A method of producing a protein-enriched soy compositions, the method comprising:
a) providing soybeans, wherein the soybeans comprise at least about 48% soy protein on a dry weight basis;
b) defatting the soybeans by solvent extraction to produce a defatted soybean composition; and
c) desolventizing the defatted soybean composition to directly produce protein-enriched white flakes that comprise at least about 65% soy protein on a dry weight basis.

Embodiment 2. The method of embodiment 1, wherein the method further comprises dehulling the soybeans, and optionally mechanically flaking or grinding the dehulled beans, prior to the defatting step.

Embodiment 3. The method of embodiment 1 or 2, wherein the method further comprises flaking the soybeans prior to the defatting step.

Embodiment 4. The method of any of embodiments 1-3, further comprising extruding the protein-enriched white flakes.

Embodiment 5. The method of any one of embodiments 1-4, wherein the protein-enriched white flakes have one or more of (i) to (vi):
(i) less than or equal to about 3% crude fat on a dry weight basis;
(ii) less than or equal to about 5% fat on a dry weight basis (as determined by acid hydrolysis);
(iii) less than or equal to about 20% total dietary fiber on a dry weight basis;
(iv) less than or equal to about 7% ash on a dry weight basis; or
(v) less than or equal to about 12% moisture on a dry weight basis;
(vi) any combinations of (i)-(v).

Embodiment 6. The method of any one of embodiments 1-5, wherein the protein-enriched white flakes have at least about 4% total sugars on a dry weight basis.

Embodiment 7. The method of any one of embodiments 1-6, wherein the protein-enriched white flakes have:
(i) at least about 0.05% raffinose on a dry weight basis;
(ii) at least about 0.5% stachyose on a dry weight basis; or
(iii) a combination of (i) and (ii).

Embodiment 8. The method of any one of embodiments 1-7, wherein the protein-enriched white flakes have:
(i) at least about 0.2% raffinose on a dry weight basis;
(ii) at least about 1% stachyose on a dry weight basis; or
(iii) a combination of (i) and (ii).

Embodiment 9. The method of any one of embodiments 1-8, wherein the protein-enriched white flakes have one or more improved characteristics selected from improved average ratio of 11S soy protein (glycinin) to 7S soy protein (B-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof.

Embodiment 10. The method of any one of embodiments 1-9, wherein the protein-enriched white flakes have one or more of (i) to (vi):
(i) at least about 1% saponins on a dry weight basis;
(ii) at least about 50 mg/g of B-conglycinin (7S soy protein) on a dry weight basis;
(iii) at least about 10 ppm glycinin (11S soy protein) antigen;
(iv) at least about 10 ppm of lectins; or
(v) less than or equal to 20 mg isoflavones per 100 gram protein-enriched soy ingredient; or
(vi) any combinations of (i)-(v).

Embodiment 11. The method of any one of embodiments 1-10, further comprising grinding the protein-enriched white flakes to provide a protein-enriched soy flour.

Embodiment 12. Protein-enriched white flakes produced according to the method of any one of embodiments 1-10.

Embodiment 13. Protein-enriched white flakes, comprising:
(i) at least about 65% soy protein on a dry weight basis; and
(ii) at least about 4% sugars on a dry weight basis, wherein the sugars are present in the soybeans from which the protein-enriched white flakes were obtained.

Embodiment 14. The protein-enriched white flakes of embodiment 13, comprising one or more of (i) to (vi):
(i) less than or equal to about 3% crude fat on a dry weight basis;
(ii) less than or equal to about 5% fat on a dry weight basis (as determined by acid hydrolysis);
(iii) less than or equal to about 20% total dietary fiber on a dry weight basis;
(iv) less than or equal to about 7% ash on a dry weight basis; or
(v) less than or equal to about 12% moisture on a dry weight basis;
(vi) any combinations of (i)-(v).

Embodiment 15. The protein-enriched white flakes of embodiment 13 or 14, having
(i) at least about 0.05% raffinose on a dry weight basis;
(ii) at least about 0.5% stachyose on a dry weight basis; or
(iii) a combination of (i) and (ii).

Embodiment 16. The protein-enriched white flakes of any one of embodiments 13-15, having
(i) at least about 0.2% raffinose on a dry weight basis;
(ii) at least about 1% stachyose on a dry weight basis; or
(iii) a combination of (i) and (ii).

Embodiment 17. The protein-enriched white flakes of embodiment 13-16, having one or more improved characteristics selected from improved average ratio of 11S soy protein (glycinin) to 7S soy protein (B-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof.

Embodiment 18. A method of producing a protein-enriched soy compositions, the method comprising:

a) providing soybeans, wherein the soybeans comprises at least about 48% soy protein on a dry weight basis;

b) defatting the soybeans by solvent extraction to produce a defatted soybean composition;

c) desolventizing the defatted soybean composition to directly produce protein-enriched white flakes; and

d) grinding the protein-enriched white flakes to provide a protein-enriched soy flour, wherein the protein-enriched soy flour comprises at least about 60% soy protein on a dry weight basis.

Embodiment 19. The method of embodiment 18, wherein the method further comprises dehulling the soybeans, and optionally mechanically flaking or grinding the dehulled beans, prior to the defatting step.

Embodiment 20. The method of embodiment 18 or 19, wherein the method further comprises flaking the soybeans prior to the defatting step.

Embodiment 21. The method of any of embodiments 18-20, further comprising toasting the protein-enriched white flakes, prior to grinding the protein-enriched white flakes.

Embodiment 22. The method of any one of embodiments 18-21, wherein the protein-enriched soy flour has one or more of (i) to (vi):
(i) less than or equal to about 3% crude fat on a dry weight basis;
(ii) less than or equal to about 5% fat on a dry weight basis (as determined by acid hydrolysis);
(iii) less than or equal to about 20% total dietary fiber on a dry weight basis;
(iv) less than or equal to about 7% ash on a dry weight basis; or
(v) less than or equal to about 12% moisture on a dry weight basis;
(vi) any combinations of (i)-(v).

Embodiment 23. The method of any one of embodiments 18-22, wherein the protein-enriched soy flour has at least about 4% total sugars on a dry weight basis.

Embodiment 24. The method of any one of embodiments 18-23, wherein the protein-enriched soy flour has:
(i) at least about 0.05% raffinose on a dry weight basis;
(ii) at least about 0.5% stachyose on a dry weight basis; or
(iii) a combination of (i) and (ii).

Embodiment 25. The method of any one of embodiments 18-24, wherein the protein-enriched soy flour has:
(i) at least about 0.2% raffinose on a dry weight basis;
(ii) at least about 1% stachyose on a dry weight basis; or
(iii) a combination of (i) and (ii).

Embodiment 26. The method of any one of embodiments 18-25, wherein the protein-enriched soy flour has one or more improved characteristics selected from improved average ratio of 11S soy protein (glycinin) to 7S soy protein (B-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof.

Embodiment 27. The method of any one of embodiments 11 and 18-26, further comprising extruding the protein-enriched soy flour to produce a protein-enriched texturized soy flour comprising at least about 60% soy protein on a dry weight basis.

Embodiment 28. Protein-enriched soy flour produced according to the method of any one of embodiments 11 and 18-26.

Embodiment 29. Protein-enriched soy flour, comprising:
(i) at least about 60% soy protein on a dry weight basis;
(ii) at least about 4% sugars on a dry weight basis, wherein the sugars are present in the soybeans from which the protein-enriched soy flour was obtained.

Embodiment 30. The protein-enriched soy flour of embodiment 29, wherein the protein-enriched soy flour comprises at least about 65% soy protein on a dry weight basis.

Embodiment 31. The protein-enriched soy flour of embodiment 29 or 30, comprising one or more of (i) to (vi):
(i) less than or equal to about 3% crude fat on a dry weight basis;
(ii) less than or equal to about 5% fat on a dry weight basis (as determined by acid hydrolysis);
(iii) less than or equal to about 20% total dietary fiber on a dry weight basis;
(iv) less than or equal to about 7% ash on a dry weight basis; or
(v) less than or equal to about 12% moisture on a dry weight basis;
(vi) any combinations of (i)-(v).

Embodiment 32. The protein-enriched soy flour of any one of embodiments 29-31, having
(i) at least about 0.05% raffinose on a dry weight basis;
(ii) at least about 0.5% stachyose on a dry weight basis; or
(iii) a combination of (i) and (ii).

Embodiment 33. The protein-enriched soy flour of any one of embodiments 29-32, having
(i) at least about 0.2% raffinose on a dry weight basis;
(ii) at least about 1% stachyose on a dry weight basis; or
(iii) a combination of (i) and (ii).

Embodiment 34. The protein-enriched soy flour of any one of embodiments 29-33, having one or more improved characteristics selected from improved average ratio of 11S soy protein (glycinin) to 7S soy protein (B-conglycinin), lower concentration of raffinose, lower concentration of stachyose, lower concentration of sucrose, lower concentration of lipoxygenase, lower concentration of trypsin inhibitor, lower concentration of linoleic acid, lower concentration of linolenic acid, lower concentration of lipoxygenase activity, higher concentration of oleic acid, higher concentration of palmitic acid, higher concentration of steric acid, or any combination thereof.

Embodiment 35. Protein-enriched texturized soy flour obtainable by or produced according to the method of embodiment 27.

Embodiment 36. Protein-enriched texturized soy flour, comprising:
(i) at least about 60% soy protein on a dry weight basis;
(ii) at least about 4% sugars on a dry weight basis, wherein the sugars are present in the soybeans from which the protein-enriched texturized soy flour was obtained.

Embodiment 37. A food product, a beverage product, a dietary supplement product or other product, comprising protein-enriched white flakes according to any one of embodiments 12-17, a protein-enriched soy flour of any one of embodiments 28-34, or a protein-enriched texturized soy flour of embodiment 35 or 36.

### EXAMPLES

The presently disclosed subject matter will be better understood by reference to the following Examples, which are provided as exemplary of the invention, and not by way of limitation.

### Example 1: Process for Preparing Protein-Enriched White Flakes

High protein soybeans, with a protein content of about 48%, are first cleaned to remove foreign matter and loose hulls. The beans are then passed through driers to reduce their moisture content to approximately 10 to 11 percent by weight, and are then tempered and stored for 1 to 5 days in order to facilitate dehulling.

The beans are then cracked using corrugated cracking rolls. The rolls crack each bean into four to six particles, and aspiration is used to remove the hulls.

The cracked beans are then conditioned using heat and steam, in order to make them pliable and facilitate flaking. The conditioned, cracked beans are then fed into smooth cylindrical rollers which press the beans into flakes, which vary in thickness from approximately 0.25 mm to 0.50 mm. Flaking allows the soybean oil cells to be exposed and the oil to be more easily extracted.

A hexane extraction process is then used to extract the oil from the flakes. The flakes are washed with hexane using a countercurrent extractor.

Following extraction, hexane is removed from the flakes via flash desolventizing under controlled times and temperatures to minimize protein denaturation. In order to remove the remaining hexane, the flakes are further processed by vacuum stripping with superheated steam under an approximately 0.5 barg vacuum to lower the remaining hexane concentration to 500 ppm. The flakes are then cooled to within 10 to 20° C. of ambient temperature by passing air through the material. The resulting white flakes have a protein content of approximately 65%.

### Example 2: Analytical Methods for Assessing Components and Properties of Protein Compositions

The present example describes exemplary analytical methods that may be used to characterize the composition and functionality of the protein-enriched soy compositions as provided herein.

### Protein

Protein content of a soy composition is measured using the Kjeldahl method (Wybraniec S., et. al. An overview of the Kjeldahl method of nitrogen determination. Part II. Sample preparation, working scale, instrumental finish and quality control. Crit. Rev. Anal. Chem. 2013; 43:224-272.). First, the sample to be analyzed is heated to 360-410° C. and digested using concentrated sulfuric acid in the presence of a catalyst, such as selenium or copper. Next, the pH of the solution is raised using sodium hydroxide in order to convert any ammonium (NH₄⁺) in solution (derived from nitrogen in the digested sample) in to ammonia gas (NH₃), which is then distilled off into an aqueous HCl solution of known volume and concentration. This solution may then be titrated in order to determine its pH, and back-calculate the amount of nitrogen in the original sample. The approximate percent weight of protein in a sample is calculated by multiplying the percent weight of nitrogen in the original sample by a factor of 6.25.

### Fats

Fat content of a soy composition is measured using the Soxhlet method (AOAC (1990) method 945.39). First, moisture is removed from the sample, and the desiccated sample is ground into a powder and weighed. Then, a soxhlet extractor is employed to extract any lipids from the sample using petroleum ether. Once the lipids in a sample have been fully extracted, the sample is weighed again, and the difference in mass is used to determine the mass of lipids originally present in the sample.

### Ash

Ash content of a soy composition is measured using standard methods. A sample of the soy composition is first dried. Then, the sample is weighed. The sample is then placed in a crucible, and placed in a high temperature muffle furnace for a period of 24 hours at 500 to 600° C. in order to dry ash the sample. Once the sample has been ashed, the remaining solids are weighed in order to determine the weight percent of ash in the sample.

### Carbohydrates

The total carbohydrate content of a soy composition is measured by first calculating the protein, fat, and ash (mineral) content of a sample on a dry basis. The carbohydrate composition is the percent mass of the dry composition which is not accounted for by these four components.

### Fiber

Fiber content of a soy composition is measured using standardized methods (AOAC (1990) method 985.29). Wherein duplicate test portions of the sample are digested with enzymes (i) a-amylase, (ii) protease, (iii) amyloglucosidase. The residue is allowed to precipitate and is filtered. One residue goes for protein analysis, the other for ash analysis.

$$Total dietary fiber = weight of the residue - weight ( ash + protein ) .$$

### Stachyose

Stachyose content of a soy composition is measured using a high performance anion exchange chromatography coupled with pulsed amperometric detection (HPAEC-PAD) (AOAC 2001.02) method, wherein a buffered extract of the sample is treated with an enzyme, β-galactosidase, that hydrolyzes trans-galactooligosaccharides to galactose and glucose. Galactose and other sugars are separated on a high performance anion-exchange chromatography column and detected by pulsed amperometric detection (PAD) using a triple potential waveform.

### Raffinose

Raffinose content of a soy composition is measured using the standardized HPAEC-PAD method (AOAC 2001.02) or an HPLC method.

### Protein Dispersibility Index

Protein dispersibility index (PDI) of a soy composition is measured as follows: 20 g of a soy sample is weighed and blended. 300 mL deionized water is measured and 50 mL of the deionized water is added to the blended soy sample. The deionized water and blended soy sample are stirred to form a paste. The remaining 250 mL of deionized water is added to the paste, and the remaining deionized water and paste are blended at 8500 rpm for 10 minutes. After 10 minutes, the blended mixture is centrifuged at 2700 rpm for 10 minutes. The supernatants from the centrifuged samples are collected and weighed. The protein content of the supernatant is determined relative to the protein content of the original soy sample, and the PDI is calculated as the percentage of the protein in the supernatant divided by the percentage in the original soy sample (a PDI of 100 indicates total solubility).

### Foaming Capacity and Stability

The foaming properties of a soy composition are measured as generally described by Boyle (Boyle, C., Hansen, L., Hinnenkamp, C. and Ismail, B. P. (2018), Emerging Camelina Protein: Extraction, Modification, and Structural/Functional Characterization. J Am Oil Chem Soc, 95:1049-1062.).

Foaming capacity is determined as follows: triplicate protein dispersions are prepared at 0.5% w/w, 200 mL water. The pH of the dispersions is adjusted to 7.0 as needed. The dispersions are stirred for 2 hours at 420 rpm. 50 g of each dispersion sample is blended at 800-900 rpm for 2 minutes. The blended samples are poured into a graduated cylinder, and the total volume, as well as the individual volumes of the liquid portion and foam portion are measured. The blended samples are allowed to stand for 30 minutes, and the total volume and individual volumes of the liquid portion and foam portion, are measured after 30 minutes have elapsed. The foam capacity is determined by measuring the foam volume after whipping. The liquid percentage is determined by measuring the liquid that was not incorporated into the foam system. Foaming Capacity=Total solution volume-liquid volume/(grams of protein).

Foaming stability is determined as the foam volume that remained for 30 min at room temperature: Foam stability (%)= [Total solution volume_{30 mins}−liquid volume_{30 min}]/[Total solution volume_{0 min}−liquid volume_{0 min}]*100.

### Viscosity

Viscosity of a soy composition is measured as follows: a soy sample is weighed and mixed with a certain volume of water to a specific dry solid concentration. The mixture is placed in a suitable container for analysis by a viscometer. The mixture is subjected to a temperature ramp program and stirring program as follows: start at 25° C. for 5 min, increases to 95° C. at the rate of 12° C./min, hold at 95° C. for 6 min, cool down from 95° C. at the rate of 12° C./min; stir at 960 rpm for 1 min and decrease to 160 rpm.

### Water Holding Capacity

Water holding capacity of a soy composition is measured using the AACC Approved Methods of Analysis AACC 56-30.1 (“Water hydration capacity of protein materials”); and or AACC 56-37.01 (“Water holding capacity of pulse flours and protein materials”).

### Oil Holding Capacity

Oil holding capacity of a soy composition is measured as generally described in by Brishti (Brishti, F. H., Zarei, M. et al. International Food Research Journal 24 (4): 1595-1605 (August 2017). Evaluation of the functional properties of mung bean protein isolate for development of textured vegetable protein.): 1 g (or 2.5g) of soy sample is weighed in a tared centrifuge tube. 10 g (or 20 g) of soybean oil is added and homogenized for 2 minutes Samples are left at room temperature for 30 minutes to allow protein to fully bind the oil. During the 30-minute period, the sample is further mixed for 30 seconds in a vortex mixer, at 15-minute intervals. The mixture is then centrifuged at 5000 g for 30 minutes. The supernatant oil is decanted and the new mass of the remaining sediment of the sample recorded, wherein the oil holding capacity (OHC) is calculated as the difference of the oily sediment after centrifugation and the dry soy sample, divided by the weight of the dry sample: OHC=(mass_{oiled}−mass_{dry})/mass_{dry}.

### Emulsification Properties

The emulsification activity and stability of a soy composition may be measured spectrophotometrically as described below.

A protein solution of 0.1-0.25% protein content is prepared with the soy sample. The solution is stirred until completely solubilized. The pH of the protein solution is adjusted to pH 9.5, and the sample is placed in a refrigerator overnight at 4° C. A standard solution of 0.1% SDS (1 g SDS to 1000 mL of deionized water) is prepared and placed in a spectrophotometry cuvette. The spectrophotometer is set to detection wavelength 500 nm and the standard solution of 0.1% SDS is used as a blank.

After storage overnight, 12.5 mL of corn oil and 37.5 mL of protein solution are combined in a beaker. The mixture is homogenized at 13,000 rpm for 2 minutes, and allowed to stand for 1 minute after homogenization. 0.5 mL of homogenized liquid is pipetted from the bottom of the beaker and mixed with 50 mL of 0.1 SDS standard solution. The mixture is placed in a sample cuvette, and the sample cuvette placed into the spectrophotometer. Absorbance is measured to give an initial absorbance A₀. After ten minutes, a second sample cuvette is prepared with 0.5 mL of homogenized liquid from the bottom of the beaker and mixed with 50 mL of 0.1 SDS standard solution. The second sample cuvette is placed into the spectrophotometer and a second absorbance measurement A₁₀ is taken.

The Emulsification activity and Emulsification stability are calculated as follows:

$$Emulsion Activity = 2 ⋆ 2.303 ⋆ \frac{A 0 \times D}{C \times ( 1 - φ ) \times 1 {0}^{4}}$$

$$Emulsion Stability : \frac{{A}_{0}}{{A}_{0} - {A}_{10}} * 10$$

wherein A₀ and A₁₀ represent the absorbance at 0 and 10 min, respectively. D is dilution factor (100), C is the protein concentration (0.001 g/mL), q is the volume fraction of corn oil (0.25).

### Minimum Gelling Concentration

The minimum gelling concentration of a soy composition is measured using the Least Gelatinization Concentration (LGC). The method is conducted as follows: various sample suspensions (40 mL) are prepared in test tubes at concentrations of 5%, 7.5%, 10%, 12.5%, 15%, 17.5, and 20%. The pH is adjusted to 7.0 and the suspensions are stirred for 1 hour at room temperature. The suspensions are then heated at 95° C. for 30 minutes, and allowed and cooled to room temperature. The suspensions are refrigerated overnight at 4° C. The suspensions are removed form the refrigerator and visually evaluated for observable movement when inverted. The minimum gelling concentration is the concentration at which the sample does not fall from the inverted test tube.

### Gelling Strength

Gelling strength of a soy composition is measured using AACC Approved Methods of Analysis 54-10.01 Extensigraph Method.

### Bulk Density

Bulk density of a soy composition is measured as follows: a beaker marked with a pre-determined volume marked on its external surface is tared. A soy sample is added to the beaker to the pre-determined volume. The weight of the soy sample is measured, and the bulk density is calculated as the weight of the soy sample divided by the volume. Bulk density (g/L)=sample weight/(predetermined volume (mL)/1000).

### Texture Properties

Texture properties of a soy composition, such as hardness, adhesiveness, cohesiveness, brittleness, elastic quality, gumminess and chewiness may be evaluated with a texture analyzer and suitable attachments.

A soy sample is prepared for texture analysis as follows: the soy sample is screened through a screen with mesh #4 and retained on a screen with mesh #5 in order to obtain suitable particulate sample size. 100 g of the screened sample material is weighed and mixed with 1000 g of distilled water. The screened sample material and water are allowed to sit for 1 hour at ambient temperature. The water is drained from the soaked sample material, and the soaked sample material is drained and screened on a screen with mesh #12. The hydrated solids retained on the mesh screen with mesh #12 are covered for 30 minutes. The hydrated solids are weighed. The water absorption capacity is determined by determining the amount of water absorbed per 100 gram of soy sample: Water absorption capacity (g/100 g)= (weight of #12 screen and hydrated TVP−the screen weight−70)/70 (g/100g).

The hydrated solids are collected for texture analysis and the water drained from the hydrated solids are retained to determine solid content and to calculate dry matter loss from the initial soy sample during soaking.

The hydrated solids are weighed (approximately 70 g) and placed into Kramer shear cell. The sample in the cell is shaken to ensure even distribution and secure sealing of the cell. The cell is fitted and aligned onto the texture analyzer fitted with the blade for the Kramer shear cell. The plunger speed is set to 10 mm/s, the trigger force at 10 g, and the compressing distance at 61 mm. The maximal force applied to the sample in the Kramer shear cell is recorded to determine firmness.

The water drained from the hydrated solids (“soaking water”) can be evaluated for solid content in order to determine dry matter loss from the initial soy sample. 10 g of the drained water is collected into a suitable container and oven-dried at 50° C. overnight. The dried sample remaining in the container is placed in a desiccator for 1 hour. After 1 hour, the weight of the dried sample is recorded. The solid content of the soaking water is calculated as follows: Solid content (%)=weight of dried sample/weight of soaking water in moisture pan (%). The dry matter loss from the initial soy sample can be further calculated as follows:

$$Dry matter loss ( \% ) = ( weight of soaking water collected \times solid content of soaking water ) \text{} / 70 ( \% ) .$$

### Example 3: Process for Preparing Protein-Enriched Soy Flour

High protein soybeans, with a protein content of about 48%, are first cleaned to remove foreign matter and loose hulls. The beans are then passed through driers to reduce their moisture content to approximately 10 to 11 percent by weight, and are then tempered and stored for 1 to 5 days in order to facilitate dehulling.

The beans are then cracked using corrugated cracking rolls. The rolls crack each bean into four to six particles, and aspiration is used to remove the hulls.

The cracked beans are then conditioned using heat and steam, in order to make them pliable and facilitate flaking. The conditioned, cracked beans are then fed into smooth cylindrical rollers which press the beans into flakes, which vary in thickness from approximately 0.25 mm to 0.50 mm. Flaking allows the soybean oil cells to be exposed and the oil to be more easily extracted.

A hexane extraction process is then used to extract the oil from the flakes. The flakes are washed with hexane using a countercurrent extractor.

Following extraction, hexane is removed from the flakes via flash desolventizing. The de-oiled flakes are fed into a high-velocity stream of superheated solvent vapors to evaporate solvent from the flakes. The de-oiled flakes enter the stream at approximately 55° C. to 60° C. with 25 to 35% liquid hexane and 8 to 10% moisture. After approximately 2 seconds, the flakes exit the tube at approximately 105° C. with 1 to 2% liquid hexane and 6 to 8% moisture remaining. In order to remove the remaining hexane, the flakes undergo vacuum stripping with superheated steam under an approximately 0.5 barg vacuum to lower the remaining hexane concentration to 500 ppm. The flakes are then cooled to within 10 to 20° C. of ambient temperature by passing air through the material.

The resulting white flakes have a protein content of approximately 60%. To produce high-protein soy flour, these white flakes are then milled until at least about 95% of the product can pass through a 100-mesh (150 micron) standard screen.

### Example 4: Functional Properties of an Exemplary Soy Flour

An exemplary protein-enriched soy flour (Example Soy Flour #1) was prepared according to a similar protocol, using high protein soybeans, as described in Example 3. The composition and physical properties of the protein-enriched soy flour were characterized, as shown in Table 1.

TABLE 1
Chemical and Physical Characteristics
of a Protein-Enriched Soy Flour

| | | | Example | Commercial | Commercial |
|---|---|---|---|---|---|
| | | | Soy | Soy | Soy |
| Products | | | Flour #1 | Flour #1 | Flour #2 |
| Physical | Density (g/cm³) | | 0.53 | 0.55 | 0.5 |
| Properties | Particle | d(0.5) | 27.7 | 27.2 | 27.6 |
| | Size | (μm) | | | |
| | | d(0.9) | 170 | 121 | 145 |
| | | (μm) | | | |

| | | | | |
|---|---|---|---|---|
| Chemical | Moisture (%) | 4.6 | 4.6 | 4.9 |
| Composition | Protein (%, d.b.) | 61.8 | 53.8 | 53.2 |
| | Lipid (%, d.b.) | 0.4 | | 0.6 |
| | Ash (%, d.b.) | 6.8 | 6.9 | 7.4 |
| | Crude Fiber | 2.5 | | 2.6 |

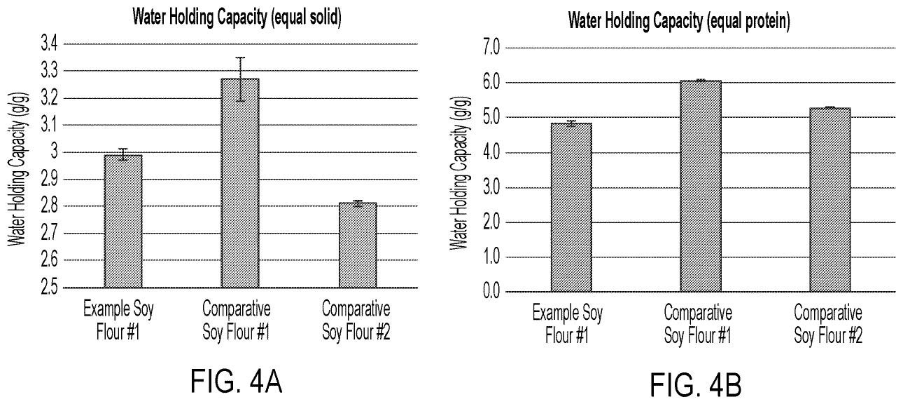

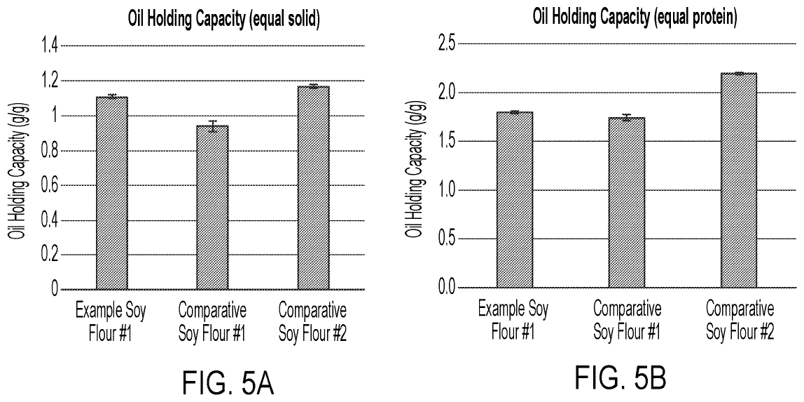

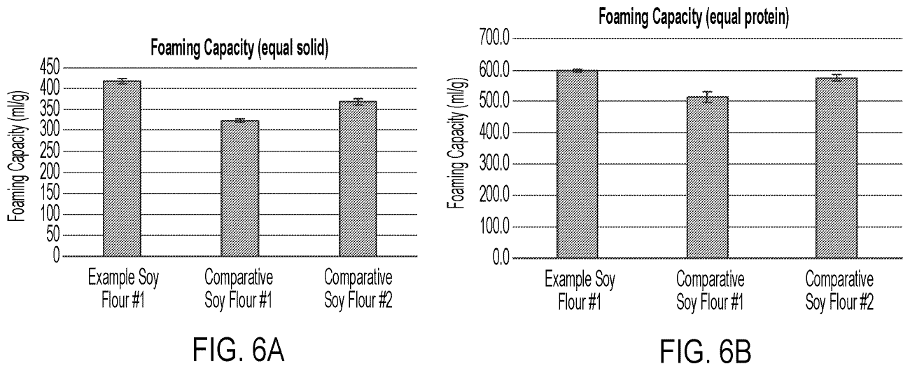

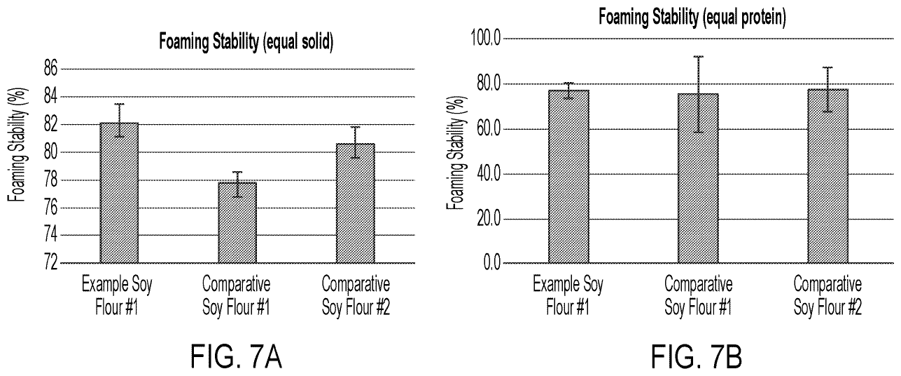

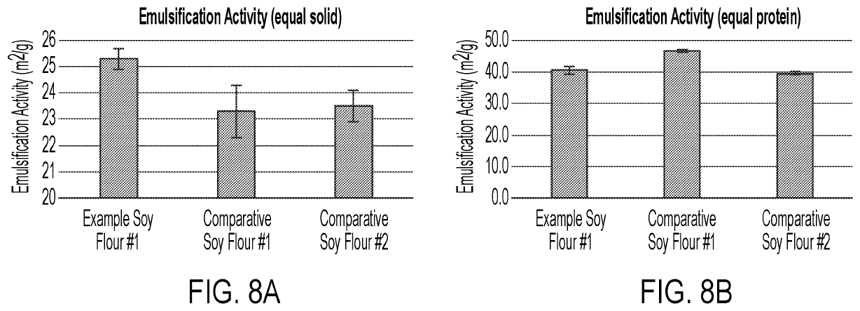

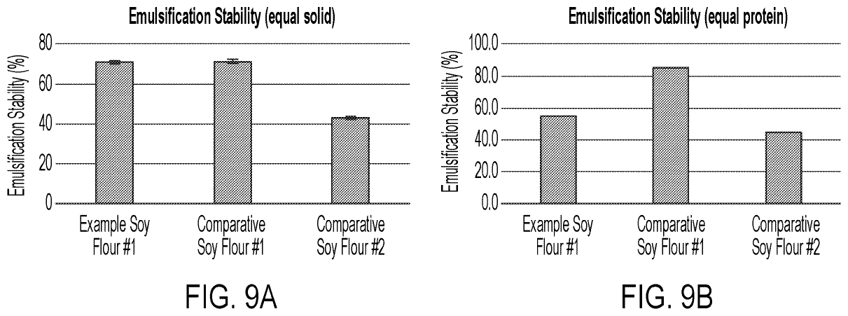

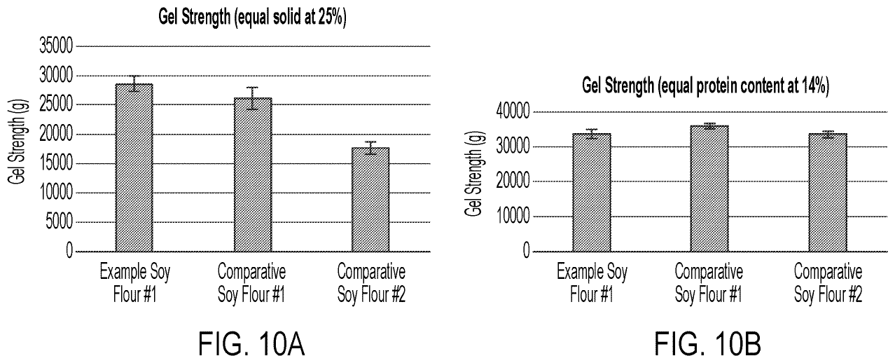

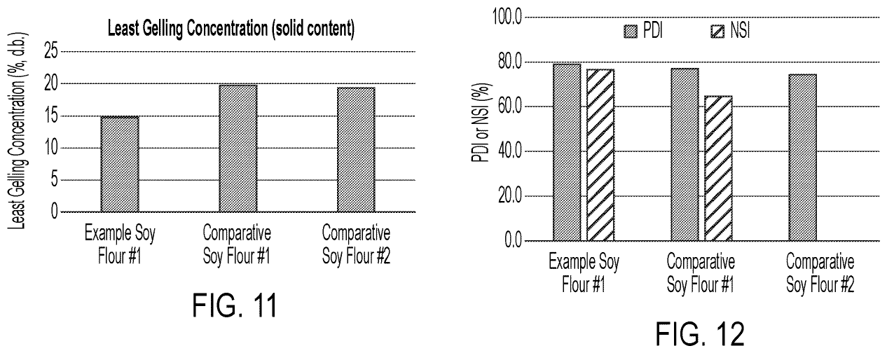

The Example Soy Flour #1 was also evaluated for nutritional content, water and oil holding capacity, foaming capacity and stability, emulsification activity and stability, gelling, solubility, and viscosity, relative to two commercial soy flours obtained from commodity soybeans (Commercial Soy Flour #1 and Commercial Soy Flour #2). The results are shown in Tables 2 and 3, below, and FIGS. 4-12.

TABLE 2
Nutritional Content of a Protein-Enriched
Soy Flour (on a dry basis)

| | Example Soy | Commercial |
|---|---|---|
| Items | Flour #1 | Soy Flour #1 |
| Crude Protein (%) | 61.2 | 53.8 |
| Maltose (%) | 0.7 | 0.4 |
| Sucrose (%) | 12 | 8.6 |
| Fructose (%) | | 0.5 |
| Total sugars (%) | 12.8 | 9.5 |
| Insoluble dietary fiber (%) | 15.3 | 18.6 |
| Total dietary fiber (%) | 15.3 | 19.9 |
| Total Carbohydrate (%) | 30.5 | 37.2 |
| Polyunsaturated (%) | 0.9 | 1.3 |
| Monounsaturated (%) | 0.2 | 0.3 |
| Total saturated (%) | 0.5 | 0.5 |
| Total Fat as Triglycerides, %) | 1.7 | 2.2 |
| Calcium (%) | 0.3 | 0.32 |
| Potassium (%) | 2.51 | 2.44 |
| Sodium (%) | 0.02 | 0.02 |
| Iron (%) | 0.01 | 0.01 |
| Total Ash (%) | 6.6 | 6.9 |
| Calories (kcal/100 g) | 293 | 306 |

TABLE 3
Viscosity Characteristics of a Protein-Enriched Soy Flour

| | RVA Viscosity | | | | | |
|---|---|---|---|---|---|---|
| | Run at 17.5% dry solids | | | Run at 9.5% protein | | |
| Sample | Peak | Trough | Final | Peak | Trough | Final |
| Example Soy | 1741 | 2223 | 6564 | 823 | 990 | 2255 |
| Flour #1 | | | | | | |
| Comparative | 774 | 1015 | 2225 | 682 | 930 | 2127 |
| Soy Flour #1 | | | | | | |
| Comparative | 877 | 1090 | 2071 | 654 | 870 | 1816 |
| Soy Flour #2 | | | | | | |

The protein-enriched soy flour prepared according to the methods as described herein contained close to 15% more protein on a dry weight basis as compared to two commercially available soy flour obtained from commodity soybeans. Further, the Example Soy Flour #1 displayed water holding capacity, oil holding capacity, foaming capacity, foaming stability, emulsification activity, emulsification stability, gelling, solubility, and viscosity properties which were comparable to those of commodity flours on an equal protein basis, which were in many cases better than those of commodity flours on an equal solid basis. The Example Soy Flour #1 had higher foaming capacity on both equal solids basis and equal protein basis, and its viscosity was also higher on an equal solids basis and equal protein basis.

### Example 5: Environmental Footprint Assessment of Exemplary Soy Compositions

The environmental impact of three different soy products prepared from high-protein soy beans was assessed. Additionally, the resources consumed during the processing to prepare each of the three products was also calculated. As a benchmark, the same calculations were performed for analogous products prepared using commodity soybeans. The results of these calculations are shown in Table 4, below.

TABLE 4
Protein Content and Environmental Impact of Different Soy Compositions

| | | | | | CO₂ Emissions^{d} | |
|---|---|---|---|---|---|---|
| | | | | | (total at | |
| | | | | | factory gate) | CO₂ Emissions^{e} |
| | | Protein | Tap Water^{b}, | Electricity^{c}, | Tons of | (processing only) |
| Starting | | Content^{a}, | kg water/ton | kWh/ton | CO₂/ton | tons of CO₂/ton |
| Material | Composition | wt % | of product | of product | of product | of product |
| High Protein | Soybean | A | B | A | A | A |
| Soybeans | Meal | | | | | |
| | Soy White | D | B | A | A | A |
| | Flakes | | | | | |
| | Soy Flour | A | B | B | D | A |
| Commodity | Soybean | B | D | D | * | * |
| Soybeans | Meal | | | | | |
| | Soy White | B | D | D | B | * |
| | Flakes | | | | | |
| | Soy Flour | B | A | B | B | * |

^{a}A = >50%; B = ≤50%
^{b}A = ≤400 kg water; B = >400 kg water
^{c}A = ≤100 kWh; B = >100 kWh
^{d}A = ≤0.5 tons CO₂/ton of product; B = >0.5 tons CO₂/ton of product
^{e}A = <0.1 tons CO₂/ton of product
* data not available

Water use reflects the total amount of water withdrawn from its source and which might return to a watershed, as for instance in the case of cooling water in a power plant or in the case of evaporation, after it has been used in a process.

Electricity use is defined as the total amount of electricity consumed during and as a direct result of any processes necessary to transform the soybeans into the specified product (e.g., soybean meal, soy white flakes, or soy flour).

Total CO₂ reflects the total carbon footprint of the respective product, including cultivation of the soybeans, transportation of the soybeans, and processing of the soybeans, up to the factory gate. This carbon footprint includes CO₂ released during cultivation of the soy due to emissions from agricultural machinery, CO₂ released during the production of any pesticides and synthetic fertilizers used when growing the soybeans, CO₂ released as emissions during transport of the soy to the processing location, emissions contributed as a result of any electricity or heat used during processing of the soybeans, and any CO₂ emissions related to land use change.

Processing CO₂ reflects the carbon footprint associated only with the processing of the soybeans into the specified product (e.g., soybean meal, soy white flakes, or soy flour). This carbon footprint does not include CO₂ emissions associated with the cultivation or transportation of the soybeans. This carbon footprint includes any electricity or heat used during processing. It also includes CO₂ released during the production of any additives used in processing (e.g., hexane), as well as CO₂ released during the processing of any wastewater generated during the processing step.

Reference to “about” a value or parameter herein includes (and describes) embodiments that are directed to that value or parameter per se. For example, description referring to “about X” includes description of “X”. In some embodiments, the term “about” when used in association with a measurement, or used to modify a value, a unit, a constant, or a range of values, refers to variations of +/−2%.

Reference to “between” two values or parameters herein includes (and describes) embodiments that include those two values or parameters per se. For example, description referring to “between x and y” includes description of “x” and “y” per se.

It is understood that aspects and variations described herein also include “consisting” and/or “consisting essentially of” aspects and variations.

1. A method of processing soybeans, the method comprising:
a) providing high protein soybeans, wherein the high protein soybeans comprise at least 48% soy protein on a dry weight basis;
b) defatting the high protein soybeans by solvent extraction to produce a defatted soybean composition; and
c) desolventizing the defatted soybean composition to directly produce protein-enriched white flakes that comprise at least about 55% soy protein on a dry weight basis, and
wherein:
(i) the method uses less than 500 kg of water per ton of protein-enriched white flakes produced; or
(ii) the method uses less than 100 kWh of electricity per ton of protein-enriched white flakes produced; or
(iii) the method results in the release of less than 0.06 tons of CO₂ into the atmosphere per ton of protein-enriched white flakes produced;
or any combination of (i)-(iii) above.

2. (canceled)

3. (canceled)

4. (canceled)

5. The method of claim 1, wherein the method results in the release of at least 60% less CO₂ into the atmosphere per ton of protein-enriched white flakes produced as compared to white flakes produced from commodity soybeans.

6. The method of claim 1, wherein the protein-enriched white flakes have one or more of (i) to (vi):
(i) less than or equal to about 3% crude fat on a dry weight basis;
(ii) less than or equal to about 5% fat on a dry weight basis (as determined by acid hydrolysis);
(iii) less than or equal to about 20% total dietary fiber on a dry weight basis;
(iv) less than or equal to about 7% ash on a dry weight basis; or
(v) less than or equal to about 12% moisture on a dry weight basis;
(vi) any combinations of (i)-(v).

7. The method of claim 1, wherein the protein-enriched white flakes have at least about 4% total sugars on a dry weight basis.

8. (canceled)

9. The method of claim 1, wherein the protein-enriched white flakes have:
(i) at least about 0.2% raffinose on a dry weight basis;
(ii) at least about 1% stachyose on a dry weight basis; or
(iii) a combination of (i) and (ii).

10. (canceled)

11. The method of claim 1, wherein the protein-enriched white flakes have one or more of (i) to (vi):
(i) at least about 1% saponins on a dry weight basis;
(ii) at least about 50 mg/g of β-conglycinin (7S soy protein) on a dry weight basis;
(iii) at least about 10 ppm glycinin (11S soy protein) antigen;
(iv) at least about 10 ppm of lectins; or
(v) less than or equal to 20 mg isoflavones per 100 gram protein-enriched soy ingredient; or
(vi) any combinations of (i)-(v).

12. The method of claim 1, further comprising grinding the protein-enriched white flakes to provide a protein-enriched soy flour that comprises at least about 55% soy protein on a dry weight basis.

13-21. (canceled)

22. The method of claim 12, further comprising extruding the protein-enriched soy flour to produce a protein-enriched textured soy flour comprising at least about 60% soy protein on a dry weight basis.

23. Protein-enriched white flakes produced according to the method of claim 1.

24. (canceled)

25. Protein-enriched white flakes, having at least 55% protein on a dry weight basis and at least about 4% sugars on a dry weight basis, produced according to a process that results in the release of at least 60% less CO₂ into the atmosphere per ton of protein-enriched white flakes produced as compared to white flakes produced from commodity soybeans, and wherein the sugars are present in the soybeans from which the protein-enriched white flakes were obtained.

26. (canceled)

27. The protein-enriched white flakes of claim 23, comprising one or more of (i) to (vi):
(i) less than or equal to about 3% crude fat on a dry weight basis;
(ii) less than or equal to about 5% fat on a dry weight basis (as determined by acid hydrolysis);
(iii) less than or equal to about 20% total dietary fiber on a dry weight basis;
(iv) less than or equal to about 7% ash on a dry weight basis; or
(v) less than or equal to about 12% moisture on a dry weight basis;
(vi) any combinations of (i)-(v).

28. (canceled)

29. The protein-enriched white flakes of claim 23, having
(i) at least about 0.2% raffinose on a dry weight basis;
(ii) at least about 1% stachyose on a dry weight basis; or
(iii) a combination of (i) and (ii).

30. (canceled)

31. Protein-enriched soy flour prepared according to the method of claim 12.

32-39. (canceled)

40. Protein-enriched texturized soy flour obtainable by or produced according to the method of claim 22.

41. Protein-enriched texturized soy flour, comprising:
(i) at least about 60% soy protein on a dry weight basis;
(ii) at least about 4% sugars on a dry weight basis, wherein the sugars are present in the soybeans from which the protein-enriched texturized soy flour was obtained.

42. A food product, a beverage product, a dietary supplement product or other product, comprising protein-enriched white flakes according to claim 23.

43. A method of processing soybeans, the method comprising:
a) providing high protein soybeans that comprise at least 48% soy protein on a dry weight basis;
b) defatting the high protein soybeans by solvent extraction to produce a defatted soybean composition; and
c) desolventizing the defatted soybean composition to directly produce protein-enriched soybean meal that comprises at least about 50% soy protein on a dry weight basis,
wherein:
(i) the method uses less than 500 kg of water per ton of protein-enriched soybean meal produced; or
(ii) the method uses less than 100 kWh of electricity per ton of protein-enriched soybean meal produced; or
(iii) the method results in the release of less than 0.06 tons of CO₂ into the atmosphere per ton of protein-enriched soybean meal produced;
or any combination of (i)-(iii) above.

44. (canceled)

45. (canceled)

46. (canceled)

47. Protein-enriched soybean meal having at least 50% protein on a dry weight basis, produced according to the method of claim 43.

48. (canceled)

49. The protein-enriched soybean meal of claim 47, further comprising at least about 4% sugars on a dry weight basis, wherein the sugars are present in the soybeans from which the protein-enriched soybean meal was obtained.

50. The protein-enriched soybean meal of claim 47, having
(i) at least about 0.2% raffinose on a dry weight basis;
(ii) at least about 1% stachyose on a dry weight basis; or
(iii) a combination of (i) and (ii).

51. A food product, a beverage product, a dietary supplement product or other product, comprising a protein-enriched soybean meal according to claim 47.
